(19) United States
(12) Patent Application Publication
(10) Pub. No.: US 2025/0084505 A1
(43) Pub. Date: Mar. 13, 2025

(54) HIGH STRENGTH ALUMINIUM ALLOYS CONTAINING SILICON AND COPPER FOR USE IN ADDITIVE MANUFACTURING AND METHOD OF USING THE SAME

(71) Applicant: Technology Innovation Institute - Sole Proprietorship LLC, Masdar City (AE)

(72) Inventors: Federico Bosio, Abu Dhabi (AE); Giuseppe Del Guercio, Abu Dhabi (AE); Chinmay Phutela, Abu Dhabi (AE); Lewis Kindleyside, Abu Dhabi (AE); Nesma T. Aboulkhair, Abu Dhabi (AE); Rafael Casas, Abu Dhabi (AE)

(73) Assignee: Technology Innovation Institute - Sole Proprietorship LLC, Masdar City (AE)

(21) Appl. No.: 18/830,240

(22) Filed: Sep. 10, 2024

Related U.S. Application Data
(60) Provisional application No. 63/582,089, filed on Sep. 12, 2023.

(51) Int. Cl. C22C 1/04; B22F 1/05; B22F 9/04; B22F 9/08; B22F 10/28; B33Y 10/00; B33Y 80/00; C22C 21/02

(52) U.S. Cl. CPC C22C 1/0416; B22F 1/05; B22F 9/04; B22F 9/082; B22F 10/28; B33Y 10/00; B33Y 80/00; C22C 21/02; B22F 2202/01; B22F 2304/10; B22F 2998/10; B22F 2999/00

(57) ABSTRACT

The present disclosure describes an alloy which achieves a level of densification of 99.5% or greater and a method of making the same, wherein the method may include (a) depositing a first layer of a precursor powder including aluminum, silicon, and copper onto a build platform, (b) contacting the first layer of the precursor powder with an energy source to form a solid layer, (c) depositing a subsequent layer of the precursor powder on top of the solid layer, (d) contacting the subsequent layer of the precursor powder with the energy source to fuse the subsequent layer of the precursor powder to the solid layer, thereby forming the three-dimensional article.

### CROSS-REFERENCE TO RELATED APPLICATIONS

This application claims priority to U.S. Provisional Patent Application No. 63/582,089, filed on Sep. 12, 2023, which is hereby incorporated by reference herein in its entirety.

### FIELD

The present disclosure relates generally to alloy compositions and methods of making and using the same for additive manufacturing. More specifically, the present disclosure relates to alloy compositions containing silicon, copper, magnesium, iron, and aluminum.

### BACKGROUND

Additive manufacturing of metal parts is a powerful alternative to conventional casting routes, thanks to its capability to manufacture complex parts with high design freedom and without the need for further assembly or post-process joining. Additive manufacturing is a strategic technology which allows the opportunity to design novel alloy compositions with specific properties which cannot be generated in conventional processes. Powder Bed Fusion-Laser Beam (PBF-LB) has been previously investigated as an additive manufacturing technique; however, only a limited number of commercially available alloy compositions exist for this technology.

Developing new alloys for additive manufacturing, specifically those for powder bed fusion, is an important challenge to address in the field. The development of new alloys typically requires significant economic investment and research, due to both the cost of starting material powders and the specific particle sizes required to guarantee good flowability and prevent the formation of unwanted porosity.

Achieving a high level of densification during additive manufacturing (that is, limiting void space in the resulting part) is a significant obstacle towards the realization of new alloys, and there are numerous process parameters which can affect the alloy formation process. It is crucial to consider both the composition of the alloy itself and the additive manufacturing process parameters in designing a material which will provide high density of the printed article, excellent tensile properties, and light overall weight, where required. It remains a challenge in the industry to design and prepare such materials, and successful alloy compositions and methods of making the same are of high commercial and industrial value.

### SUMMARY

In some aspects, the techniques described herein relate to a method for forming a three-dimensional article including an alloy, the method including steps of: (a) depositing a first layer of a precursor powder onto a build platform, wherein the precursor powder includes aluminum, silicon, and copper; (b) contacting the first layer of the precursor powder with an energy source to form a solid layer of the alloy; (c) depositing a subsequent layer of the precursor powder on top of the solid layer; and (d) contacting the subsequent layer of the precursor powder with the energy source to fuse the subsequent layer of the precursor powder to the solid layer; thereby forming the three-dimensional article.

In some aspects, the techniques described herein relate to a method, wherein the precursor powder includes greater than or equal to 4 wt. % to less than or equal to 8 wt. % copper.

In some aspects, the techniques described herein relate to a method according to any of the above embodiments, wherein the precursor powder includes: greater than or equal to 4 wt. % to less than or equal to 8 wt. % copper, and greater than or equal to 8 wt. % to less than or equal to 11 wt. % silicon.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.6 wt. % manganese, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.6 wt. % magnesium, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above embodiments, further including preparing the precursor powder, wherein preparing the precursor powder includes combining a copper-containing powder with a silicon-containing powder.

In some aspects, the techniques described herein relate to a method according to any of the above embodiments, further including preparing the precursor powder, wherein preparing the precursor powder includes combining an elemental copper powder with a pre-alloyed powder including silicon, aluminum, magnesium, or combinations thereof.

In some aspects, the techniques described herein relate to a method according to any of the above embodiments, further including preparing the precursor powder, wherein preparing the precursor powder includes sizing the precursor powder to an average particle size of greater than or equal to 1 μm to less than or equal to 100 μm.

In some aspects, the techniques described herein relate to a method according to any of the above embodiments, further including preparing the precursor powder, wherein preparing the precursor powder includes sizing the precursor powder to a particle size distribution of 1 μm to 100 μm.

In some aspects, the techniques described herein relate to a method according to any of the above embodiments, further including preparing the precursor powder, wherein preparing the precursor powder includes sizing the precursor powder via vibratory sieving.

In some aspects, the techniques described herein relate to a method according to any of the above embodiments, further including preparing the precursor powder, wherein preparing the precursor powder includes ultrasonic atomization.

In some aspects, the techniques described herein relate to a method according to any of the above embodiments, further including (e) repeating steps (c) through (d) a plurality of times.

In some aspects, the techniques described herein relate to a method according to any of the above embodiments, wherein the three-dimensional article has a density of greater than or equal to 99.2%.

In some aspects, the techniques described herein relate to a method according to any of the above embodiments, wherein the three-dimensional article has a density of greater than or equal to 99.5%.

In some aspects, the techniques described herein relate to a method according to any of the above embodiments, wherein the three-dimensional article has a density of greater than or equal to 99.9%.

In some aspects, the techniques described herein relate to a method according to any of the above embodiments, wherein the alloy has a hardness of greater than or equal to 140 HV to 200 HV, a hot crack susceptibility coefficient of less than or equal to 0.3, and a density of 99.2% or greater.

In some aspects, the techniques described herein relate to a method for producing an alloy structure having a density of greater than or equal to 99.2%, including: providing a precursor powder including greater than or equal to 4 wt. % to less than or equal to 8 wt. % copper to an additive manufacturing system; and contacting the precursor powder with an energy source to form the alloy structure.

In some aspects, the techniques described herein relate to a method, wherein the precursor powder includes: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum.

In some aspects, the techniques described herein relate to a method according to any of the above embodiments, wherein the precursor powder includes: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.

In some aspects, the techniques described herein relate to a method according to any of the above embodiments, wherein the precursor powder includes a mixture of a copper-containing powder and a silicon-containing powder.

In some aspects, the techniques described herein relate to a method according to any of the above embodiments, wherein the precursor powder is sized via vibratory sieving prior to contacting the precursor powder with an energy source.

In some aspects, the techniques described herein relate to a method according to any of the above embodiments, wherein the precursor powder is sized to an average particle size of greater than or equal to 1 μm to less than or equal to 100 μm prior to contacting the precursor powder with the energy source.

In some aspects, the techniques described herein relate to a method according to any of the above embodiments, wherein the precursor powder has a particle size distribution of 1 μm to 100 μm.

In some aspects, the techniques described herein relate to a method according to any of the above embodiments, wherein providing the precursor powder includes depositing the precursor powder onto a build plate, wherein the build plate is at a temperature of greater than or equal to 100° C. to less than or equal to 300° C.

In some aspects, the techniques described herein relate to a method according to any of the above embodiments, wherein contacting the precursor powder with the energy source results in fusing the precursor powder to consolidate the alloy structure, such that the alloy structure has a density of greater than or equal to 99.2%.

In some aspects, the techniques described herein relate to a method according to any of the above embodiments, wherein contacting the precursor powder with the energy source results in fusing the precursor powder to consolidate the alloy structure, such that the alloy structure has a density of greater than or equal to 99.5%.

In some aspects, the techniques described herein relate to a method according to any of the above embodiments, wherein contacting the precursor powder with the energy source results in fusing the precursor powder to consolidate the alloy structure, such that the alloy structure has a density of greater than or equal to 99.9%.

In some aspects, the techniques described herein relate to a method according to any of the above embodiments, wherein contacting the precursor powder with the energy source results in fusing the precursor powder to consolidate the alloy structure, such that the alloy structure has a hardness of greater than or equal to 140 HV to less than or equal to 200 HV, a hot crack susceptibility coefficient of less than or equal to 0.3, and a density of greater than or equal to 99.5%.

In some aspects, the techniques described herein relate to an alloy, including: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum, wherein the alloy has a hardness of greater than or equal to 140 HV to less than or equal to 200 HV, a hot crack susceptibility coefficient of less than or equal to 0.3, and a density of greater than or equal to 99.5%.

In some aspects, the techniques described herein relate to an alloy, including greater than or equal to 5 wt. % to less than or equal to 7 wt. % copper.

In some aspects, the techniques described herein relate to an alloy according to any of the above embodiments, including 7 wt. % copper.

In some aspects, the techniques described herein relate to an alloy according to any of the above embodiments, further including greater than or equal to 0.01 wt. % to less than or equal to 0.8 wt. % iron.

In some aspects, the techniques described herein relate to an alloy according to any of the above embodiments, further including greater than or equal to 0.01 wt. % to less than or equal to 0.6 wt. % manganese.

In some aspects, the techniques described herein relate to an alloy according to any of the above embodiments, further including greater than or equal to 0.01 wt. % to less than or equal to 0.6 wt. % magnesium.

In some aspects, the techniques described herein relate to an alloy according to any of the above embodiments, further including greater than or equal to 0.01 wt. % to less than or equal to 0.3 wt. % titanium.

In some aspects, the techniques described herein relate to an alloy according to any of the above embodiments, further including greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, and greater than or equal to 0.01 wt. % to less than or equal to 0.3 wt. % titanium.

In some aspects, the techniques described herein relate to an alloy according to any of the above embodiments, wherein the alloy has a density of greater than or equal to 99.9%.

In some aspects, the techniques described herein relate to an alloy according to any of the above embodiments, wherein the alloy has an Al₂Cu phase fraction of y wt. %, wherein y=0.2052x2-0.924x+7.4253, and wherein x=Cu wt. %.

In some aspects, the techniques described herein relate to an alloy according to any of the above embodiments, wherein the alloy has a yield strength of greater than or equal to 200 MPa to less than or equal to 350 MPa.

In some aspects, the techniques described herein relate to an alloy according to any of the above embodiments, wherein the alloy has an ultimate tensile strength of greater than or equal to 350 MPa to less than or equal to 500 MPa.

In some aspects, the techniques described herein relate to an alloy according to any of the above embodiments, wherein the alloy has an elongation at failure of greater than or equal to 3% to less than or equal to 15%.

### BRIEF DESCRIPTION OF THE DRAWINGS

Aspects, features, benefits, and advantages of the embodiments described herein will be apparent with regard to the following description, appended claims, and accompanying drawings where:

FIG. 1 shows a bar graph of the hardness (HV) of various alloy compositions according to embodiments of the present disclosure compared to commercially available high-strength aluminum alloys.

FIG. 2 is a bar graph showing the hot crack susceptibility coefficient of various alloy compositions according to embodiments of the present disclosure compared to commercial grades of aluminum alloys.

FIG. 3 shows the cross-sectional micrographs of an alloy according to an embodiment of the present disclosure compared to a commercially available AlSi10Mg alloy after the PBF-LB process.

FIG. 4 is a graph of Al₂Cu phase fraction (wt. %) vs. Cu content (wt. %), according to embodiments of the present disclosure.

FIG. 5A shows the temperature vs. volume fraction of all phases for an AMALLOY3D.4 alloy according to an embodiment of the present disclosure, FIG. 5B shows the temperature vs. volume fraction of all phases for an AMALLOY3D.6 alloy according to an embodiment of the present disclosure, FIG. 5C shows the temperature vs. volume fraction of all phases for an AMALLOY3D.8 alloy according to an embodiment of the present disclosure, and FIG. 5D shows the temperature vs. volume fraction of all phases for a commercially available AlSi10Mg alloy.

FIG. 6A-6F each show an overview of the microstructures of alloys according to embodiments of the present disclosure in the first consolidated layer. FIG. 6A shows the microstructure an AMALLOY3D.4 alloy at 200 μm scale and FIG. 6B shows the same alloy at 50 μm scale. FIG. 6C shows the microstructure of an AMALLOY3D.6 alloy at 200 μm scale and FIG. 6D shows the same alloy at 50 μm scale. FIG. 6E shows the microstructure of an AMALLOY3D.8 alloy at 200 μm scale and FIG. 6F shows the same alloy at 50 μm scale.

FIG. 7 is a graph of stress-strain tensile curves of the as-built AMALLOY3D.7 alloy of the present disclosure and a commercially available AlSi10Mg alloy processed at 220° C. for 12 hours.

FIG. 8 is a bar graph showing the hot crack susceptibility coefficient of various alloy compositions according to embodiments of the present disclosure compared to commercial grades of aluminum alloys.

FIG. 9 depicts the morphology of pre-alloyed AMALLOY3D.7 powder particles characterized by a high degree of sphericity, according to an embodiment of the present disclosure.

FIG. 10 shows the particle size distribution (PSD) of the pre-alloyed AMALLOY3D.7 powders, according to an embodiment of the present disclosure, as measured by laser diffraction before the additive manufacturing process.

FIG. 11 shows micrographs of the cross-sections of pre-alloyed AMALLOY3D.7 and in-situ AMALLOY3D.7 coupons manufactured using pre-alloyed and mixed powder batches, respectively, according to embodiments of the present disclosure, compared to commercially available AlSi10Mg alloy after PBF-LB.

FIG. 12 is a bar graph showing the hot crack susceptibility coefficient of various alloy compositions according to embodiments of the present disclosure compared to commercial grades of aluminum alloys

FIG. 13 is a graph of stress-strain curves of both AMALLOY3D.7 alloys of the present disclosure and a commercially available AlSi10Mg alloy.

FIG. 14 shows SEM micrographs of pre-alloyed AMALLOY3D.7 powders according to embodiments of the present disclosure and AlSi10Mg produced using ultrasonic atomization and gas atomization, respectively.

FIG. 15 shows the break energy distribution of AlSi10Mg, In-situ AMALLOY3D.7, and pre-alloyed AMALLOY3D.7 samples, according to embodiments of the present disclosure.

### DETAILED DESCRIPTION

According to embodiments of the present disclosure, a method for preparing a three-dimensional article including an alloy is provided. The composition of the alloy and methods of utilizing this alloy in additive manufacturing are also described. The presently disclosed alloy offers a high strength composition that may be used in the production of various functional parts via additive manufacturing techniques. The present alloy may be used in numerous applications, including but not limited to the production of parts for the automotive, aerospace, and manufacturing industries. These applications may require finely designed, high performance parts which are not possible with traditional alloys and traditional manufacturing techniques.

Before describing the embodiments in detail, the following definitions are used throughout the present disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%. Stated differently, where any value is described herein as modified by the term “about”, the exact value is also disclosed.

As used herein, the term “hot crack susceptibility coefficient” refers to the metrics adopted to assess the tendency of a material to experience cracking during solidification in manufacturing processes, such as during welding, casting, and the like. A lower hot crack susceptibility coefficient suggests a material is less likely to exhibit hot cracking. Software such as Thermo-Calc may be used to determine the hot crack susceptibility coefficient of a material, as would be familiar to one skilled in the art.

As used in this disclosure, the concept of “relative density” is discussed. This term refers to the content of solid material vs. void space in an article prepared via additive manufacturing, and may also be known as infill density. That is, an article which is described as having a relative density of 99.9% will have 0.1% void space. Those skilled in the art will understand that a relative density of 100% indicates an additively manufactured article which is completely solid and has no voids within the article. It will be further understood that the concept of “relative density” is referred to as simply “density” in the art, and as such, the terms “relative density” and “density” are used interchangeably in this disclosure. “Density” as used herein refers exclusively to “relative density,” as will be apparent from the corresponding units and general context.

As used herein, “hardness” refers to a measure of the resistance to localized plastic deformation induced by either mechanical indentation or abrasion, as would be familiar to those skilled in the art. Hardness may be determined by any method including but not limited to the Vickers Hardness Test. As used herein, hardness is reported in Vickers Pyramid Number (HV).

As used herein, “yield strength” refers to its common meaning in the field of materials science; that is, the stress corresponding to the yield point at which the material begins to deform plastically. Any method of determining yield strength may be used to evaluate the compositions of the present disclosure.

As used herein, “ultimate tensile strength” refers to the maximum stress or load that a material can withstand while being stretched or pulled before breaking, and may be determined by any method including performing a tensile test and a stress-strain analysis.

As used herein, “elongation at failure” refers to the permanent stretch of a material at its failure point; that is, a measure of the ductility of the material.

As used herein, the term “AMALLOY3D” refers to the alloy grades of the present disclosure. “AMALLOY3D.x” may also be used, wherein “x” refers to the weight percent of copper included in the alloy.

In embodiments, there is provided a method for preparing a three-dimensional article formed from an alloy, the method including steps of: (a) depositing a first layer of a precursor powder including aluminum, silicon, and copper onto a build platform; (b) contacting the first layer of the precursor powder with an energy source to form a solid layer of the alloy; (c) depositing a subsequent layer of the precursor powder on top of the solid layer; and (d) contacting the subsequent layer of the precursor powder with the energy source to fuse the subsequent layer of the precursor powder to the solid layer.

In embodiments, the method can also include a step of preparing the precursor powder prior to the step of (a) depositing a first layer of the precursor powder onto a build platform. In embodiments, the precursor powder can be ready to use.

In embodiments, the precursor powder can include greater than or equal to about 4 wt. % to less than or equal to about 8 wt. % copper, relative to the total weight of the precursor powder. For example, the precursor powder can include about 4 wt. %, about 4.5 wt. %, about 5 wt. %, about 5.5 wt. %, about 6 wt. %, about 6.5 wt. %, about 7 wt. %, about 7.5 wt. %, about 8 wt. % copper, or any value contained within a range formed by any two of the preceding values.

In embodiments, the precursor powder can include greater than or equal to about 4 wt. % to less than or equal to about 8 wt. % copper, and greater than or equal to about 8 wt. % to less than or equal to about 11 wt. % silicon, relative to the total weight of the precursor powder. For example, in embodiments, the precursor powder can include about 8 wt. %, about 8.5 wt. %, about 9 wt. %, about 9.5 wt. %, about 10 wt. %, about 10.5 wt. %, about 11 wt. % silicon, or any value contained within a range formed by any two of the preceding values. The precursor powder can include any combination of copper and silicon content, such that the precursor powder includes about 4 wt. % to about 8 wt. % copper and about 8 wt. % to about 11 wt. % silicon. In embodiments, the precursor powder can include greater than or equal to about 4 wt. % to less than or equal to about 8 wt. % copper, and greater than or equal to about 8 wt. % to less than or equal to about 11 wt. % silicon, and greater than or equal to 75 wt. % to less than or equal to 88 wt. % aluminum, such that the total wt. % equals 100%.

In embodiments, the precursor powder can include a balance of aluminum, such as about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. % aluminum, or any value contained within a range formed by any two of the preceding values. The precursor powder may include any amounts of copper, silicon, iron, manganese, magnesium, titanium, aluminum, or combinations thereof as disclosed herein, such that the wt. % of the components in the precursor powder equals 100 wt. %.

In embodiments, the precursor powder can further include greater than or equal to about 0.01 wt. % to less than or equal to about 0.8 wt. % iron, such as about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. % iron, or any value contained within a range formed by any two of the preceding values. In embodiments, the precursor powder does not include iron.

In embodiments, the precursor powder can further include greater than or equal to about 0.01 wt. % to less than or equal to about 0.6 wt. % manganese, such as about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % manganese, or any value contained within a range formed by any two of the preceding values. In embodiments, the precursor powder does not include manganese.

In embodiments, the precursor powder can further include greater than or equal to about 0.01 wt. % to less than or equal to about 0.6 wt. % magnesium, such as such as about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % magnesium, or any value contained within a range formed by any two of the preceding values. In embodiments, the precursor powder does not include magnesium.

In embodiments, the precursor powder can further include greater than or equal to about 0.01 wt. % to less than or equal to about 0.3 wt. % titanium, such as such as about 0.01 wt. %, about 0.02 wt. %, about 0.03 wt. %, about 0.04 wt. %, about 0.05 wt. %, about 0.1 wt. %, about 0.15 wt. %, about 0.2 wt. %, about 0.25 wt. %, about 0.3 wt. % titanium, or any value contained within a range formed by any two of the preceding values. In embodiments, the precursor powder does not include titanium.

In embodiments, the precursor powder can further include greater than or equal to about 0.01 wt. % to less than or equal to about 0.8 wt. % iron, greater than or equal to about 0.01 wt. % to less than or equal to about 0.6 wt. % magnesium, greater than or equal to less than or equal to about 0.01 wt. % to about 0.6 wt. % manganese, greater than or equal to about 0.01 wt. % to less than or equal to about 0.3 wt. % titanium, or any combination thereof. For example, the precursor powder may include one or more of iron, manganese, magnesium, and titanium in the amounts disclosed herein.

In embodiments, preparing the precursor powder can include combining a copper-containing powder with a silicon-containing powder. For example, in embodiments, elemental copper powder may be combined with a silicon-containing powder, which may or may not include other components as described herein. For example, in embodiments, the silicon-containing powder is an aluminum-silicon-containing powder. In embodiments, the silicon-containing powder is an aluminum-silicon-magnesium-containing powder. In embodiments, preparing the precursor powder can include combining an elemental copper powder with a pre-alloyed powder which includes silicon, aluminum, magnesium, or combinations thereof.

In embodiments, preparing the precursor powder can include sizing the precursor powder via a sizing method including but not limited to vibratory sieving. In embodiments, sizing the precursor powder uses a sizing method which preserves the sphericity of the precursor powder particles. In embodiments, the precursor powder has an average particle size of greater than or equal to about 1 μm to less than or equal to about 100 μm, such as about 1 μm, about 2 μm, about 3 μm, about 4 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, or any value contained within a range formed by any two of the preceding values. In embodiments, the precursor powder includes a first population of powder particles having a first average particle size and a second population of particles having a second average particle size. In embodiments, the precursor powder further includes a third population of particles having a third average particle size. It is contemplated that any of the first average particle size, the second average particle size, or the third average particle size may have the same or different values within the range of about 10 μm to about 100 μm.

In embodiments, preparing the precursor powder can include ultrasonic atomization. In embodiments, preparing the precursor powder via ultrasonic atomization can include heating the alloy to a temperature sufficient to render the alloy molten and applying an ultrasonic frequency to the molten alloy to form an atomized alloy, followed by cooling the atomized alloy to room temperature. In embodiments, preparing the precursor powder via ultrasonic atomization can further include applying increasing pressure (above ambient pressure) to the molten alloy, purging the molten alloy with an inert gas, or a combination thereof during the atomization process. In embodiments, the atomized alloy can be collected and sieved, for example with 90 μm mesh sieves.

In embodiments, preparing the precursor powder via ultrasonic atomization can include providing a pre-alloyed composition having a chemical composition as described herein and heating to a temperature of greater than or equal to about 25° C. to less than or equal to about 950° C., such as about 25° C., about 50° C., about 100° C., about 200° C., about 300° C., about 400° C., about 500° C., about 600° C., about 700° C., about 800° C., about 900° C., about 950° C., or any value contained within a range formed by any two of the preceding values. In embodiments, preparing the precursor powder via ultrasonic atomization can include applying a frequency of greater than or equal to about 30 kHz to less than or equal to about 70 kHz, such as about 30 kHz, about 40 kHz, about 50 kHz, about 60 kHz, about 70 kHz, or any value contained within a range formed by any two of the preceding values. The frequency may be varied or held constant. An amplitude of about 100% may, in embodiments, be used with a frequency as described herein. In embodiments, preparing the precursor powder via ultrasonic atomization can include applying a pressure of greater than or equal to about 0.1 bar to less than or equal to about 2 bar, such as about 0.1 bar, about 0.5 bar, about 1 bar, about 1.5 bar, about 2 bar, or any value contained within a range formed by any two of the preceding values. For example, in embodiments, preparing the precursor powder via ultrasonic atomization can include providing a pre-alloyed composition having a chemical composition as described herein, heating to a temperature of greater than or equal to about 25° C. to less than or equal to about 950° C., applying a frequency of greater than or equal to about 30 kHz to less than or equal to about 70 kHz, applying a pressure of greater than or equal to about 0.1 bar to less than or equal to about 2 bar, or any combination thereof.

In embodiments, preparing the precursor powder can include sizing the precursor powder to a particle size distribution of about 1 μm to about 140 μm. In embodiments, the precursor powder has a D10 value between about 2 μm and about 50 μm, such as about 2 μm, about 5 μm, about 10 μm, about 15 μm, about 20 μm, about 25 μm, about 30 μm, about 35 μm, about 40 μm, about 45 μm, about 50 μm, or any value contained within a range formed by any two of the preceding values. In embodiments, the precursor powder has a D50 value between about 35 μm and about 70 μm, such as about 35 μm, about 40 μm, about 45 μm, about 50 μm, about 55 μm, about 60 μm, about 65 μm, about 70 μm, or any value contained within a range formed by any two of the preceding values. In embodiments, the precursor powder has a D90 value between about 55 μm and 100 μm, such as about 55 μm, about 56 μm, about 57 μm, about 58 μm, about 59 μm, about 60 μm, about 61 μm, about 62 μm, about 63 μm, about 64 μm, about 65 μm, about 70 μm, about 75 μm, about 80 μm, about 85 μm, about 90 μm, about 95 μm, about 100 μm, or any value contained within a range formed by any two of the preceding values. In embodiments, the precursor powder has a D10 value of about 25 μm, a D50 value of about 40 μm, and a D90 value of about 65 μm. In embodiments, the precursor powder has a D10 value of about 27 μm, a D50 value of about 42 μm, and a D90 value of about 65 μm. In embodiments, the precursor powder has a D10 value of about 45 μm, a D50 value of about 65 μm, and a D90 value of about 95 μm. Those skilled in the art will understand D10, D50, and D90 to be points on a particle size distribution curve, according to the common meaning of these terms in the field. The presently disclosed values for particle size distribution were determined by laser diffraction, though those skilled in the art that other methods of determining particle size are available and may be employed as needed.

In embodiments, the step of (a) depositing a first layer of the precursor powder onto a build platform can include depositing the precursor powder onto a build platform, wherein the build platform is at a temperature of greater than or equal to about 100° C. to less than or equal to about 300° C. For example, in embodiments, the build platform is at a temperature of about 100° C., about 110° C., about 120° C., about 130° C., about 140° C., about 150° C., about 160° C., about 170° C., about 180° C., about 190° C., 200° C., about 210° C., about 220° C., about 230° C., about 240° C., about 250° C., about 260° C., about 270° C., about 280° C., about 290° C., about 300° C., or any value contained within a range formed by any two of the preceding values. The dimensions of the build platform are not limited. Any method of depositing the first layer of the precursor powder onto the build platform is acceptable within the present method.

As will be familiar to those skilled in the art of additive manufacturing, the dimensions of each layer need not be the same (but may be the same, in embodiments), and are not particularly limited. The dimensions of each layer may be selected and set by a skilled artisan depending on the shape and parameters of the article to be produced. The following values for layer thickness are merely exemplary and are not limiting. It is contemplated that other values for layer thickness may be used and are within the scope of the present disclosure.

In embodiments, the first layer of the precursor powder can have a thickness of about 10 μm to about 200 μm. For example, in embodiments, the first layer of the precursor powder has a thickness of about 10 μm, about 20 μm, about 30 μm, about 40 μm, about 50 μm, about 60 μm, about 70 μm, about 80 μm, about 90 μm about 100 μm, about 110 μm, about 120 μm, about 130 μm, about 140 μm, about 150 μm, about 160 μm, about 170 μm, about 180 μm, about 190 μm, about 200 μm, or any value contained within a range formed by any two of the preceding values. The length and width dimensions of the first layer of the precursor powder are not limited.

In embodiments, the step of (b) contacting the first layer of the precursor powder with an energy source to form a solid layer includes the use of a laser having process parameters which may be adjusted as determined by one of ordinary skill in the art.

The process parameters used for the method described herein are not particularly limited and may be selected by a person of ordinary skill in the art based on the article to be produced and the machine used for additive manufacturing. The following process parameters are merely exemplary and are not intended to be limiting. In embodiments, the energy source can include a laser having a power of about 300 W to about 500 W and a scan speed of about 1200 mm/s to about 2200 mm/s. For example, in embodiments, the energy source may include a laser having a power of about 300 W, about 320 W, about 340 W, about 360 W, about 380 W, about 400 W, about 420 W, about 440 W, about 460 W, about 480 W, about 500 W, or any value contained within a range formed by any two of the preceding values. In embodiments, the energy source can include a laser having a scan speed of about 1200 mm/s, about 1400 mm/s, about 1600 mm/s, about 1800 mm/s, about 2000 mm/s, about 2200 mm/s, or any value contained within a range formed by any two of the preceding values. Other values and other process parameters may also be appropriate in embodiments, depending on the machine used and the article to be produced.

In embodiments, the method includes a step of (c) depositing a subsequent layer of the precursor powder on top of the solid layer. In embodiments, the subsequent layer of the precursor powder can have a thickness of about 10 μm to about 200 μm. For example, in embodiments, the subsequent layer of the precursor powder has a thickness of about 10 μm, about 20 μm, about 30 μm, about 40 μm, about 50 μm, about 60 μm, about 70 μm, about 80 μm, about 90 μm about 100 μm, about 110 μm, about 120 μm, about 130 μm, about 140 μm, about 150 μm, about 160 μm, about 170 μm, about 180 μm, about 190 μm, about 200 μm, or any value contained within a range formed by any two of the preceding values. In embodiments where multiple subsequent layers of the precursor powder are present, each individual subsequent layer may have a thickness of about 10 μm to about 200 μm as described herein. Each individual subsequent layer may have the same or different thickness, within the range of about 10 μm to about 200 μm. The length and width dimensions of the subsequent layer of the precursor powder are not limited.

In embodiments, the method can include a step of (d) contacting the subsequent layer of the precursor powder with the energy source to fuse the subsequent layer of the precursor powder to the solid layer. As described previously, the settings and parameters of the energy source are not particularly limited and may be adjusted by one skilled in the art. The parameters of the energy source used to fuse the subsequent layer(s) to the solid layer may be same or different from the parameters used to consolidate the first layer of the precursor powder into the solid layer.

In embodiments, the method can include a step of (e) repeating steps (c) through (d) a plurality of times, that is, depositing a subsequent layer of the precursor powder on top of the solid layer and contacting the subsequent layer of the precursor powder with the energy source to fuse the subsequent layer of the precursor powder to the solid layer. Steps (c) through (d) may be repeated any number of times, such as 10 times, 50 times, 100 times, 500 times, and so forth. The number of times that steps (c) through (d) are repeated is not particularly limited and may be influenced by the dimensions and complexity of the three-dimensional article to be produced.

The article that is produced by the method disclosed herein is not in any way limited and may be any size or shape and have any dimensions and features. In embodiments, the three-dimensional article formed from an alloy which is produced by the present method has a density of greater than or equal to about 99.2%, a hardness of greater than or equal to about 140 HV to less than or equal to about 200 HV, an estimated hot crack susceptibility coefficient of less than or equal to about 0.3, a yield strength (YS) of greater than or equal to about 200 MPa to less than or equal to about 350 MPa, an ultimate tensile strength (UTS) of greater than or equal to about 350 MPa to less than or equal to about 500 MPa, or any combination of these properties.

In embodiments, there is provided a method of producing an alloy structure having a density of greater than or equal to about 99.2%, including providing a precursor powder which includes greater than or equal to about 4 wt. % to less than or equal to about 8 wt. % copper to an additive manufacturing system; and contacting the precursor powder with an energy source to form the alloy structure.

In embodiments, the precursor powder can include about 4 wt. % to about 8 wt. % copper, about 8 wt. % to about 11 wt. % silicon, and about 75 wt. % to about 88 wt. % aluminum. In embodiments, the precursor powder can further include about 0.01 wt. % to about 0.8 wt. % iron, about 0.01 wt. % to about 0.6 wt. % manganese, about 0.01 wt. % to about 0.6 wt. % magnesium, about 0.01 wt. % to about 0.3 wt. % titanium, or any combination thereof. As described herein, the precursor powder may include any amounts of copper, silicon, iron, manganese, magnesium, titanium, aluminum, or combinations thereof as disclosed herein, such that the total wt. % of the components in the precursor powder equals 100 wt. %.

In embodiments, the precursor powder can include a mixture of a copper-containing powder and a silicon-containing powder, such as an elemental copper powder and a pre-alloyed silicon-containing powder, as described herein.

In embodiments, the additive manufacturing system can include directed energy deposition, powder bed fusion, or combinations thereof. In embodiments, the additive manufacturing system includes powder bed fusion with a laser beam or an electron beam.

In embodiments, the energy source can include a laser having a power of about 300 W to about 500 W and a scan speed of about 1200 mm/s to about 2200 mm/s, as described herein. The process parameters of the energy source are not particularly limited and may be adjusted as required.

In embodiments, the precursor powder can be sized via vibratory sieving prior to contacting the precursor powder with an energy source. Sizing the precursor powder may be performed by any method as disclosed herein using the conventional parameters and instruments familiar to those skilled in the art. In embodiments, the precursor powder can be sized to an average particle size of about 1 μm to about 100 μm.

In embodiments, providing the precursor powder can include depositing the precursor powder onto a build plate at a temperature of greater than or equal to about 100° C. to less than or equal to about 300° C. For example, in embodiments, the build plate is at a temperature of about 100° C., about 110° C., about 120° C., about 130° C., about 140° C., about 150° C., about 160° C., about 170° C., about 180° C., about 190° C., 200° C., about 210° C., about 220° C., about 230° C., about 240° C., about 250° C., about 260° C., about 270° C., about 280° C., about 290° C., about 300° C., or any value contained within a range formed by any two of the preceding values.

In embodiments, contacting the precursor powder with the energy source results in solidifying the precursor powder to consolidate the alloy structure, such that the alloy structure has a density of greater than or equal to about 99.2%. In embodiments, contacting the precursor powder with the energy source results in solidifying the precursor powder to consolidate the alloy structure, such that the alloy structure has a density of greater than or equal to about 99.5%, such as about 99.5%, about 99.6%, about 99.7%, about 99.8%, about 99.9%, about 100.0%, or any value contained within a range formed by any two of the preceding values. In embodiments, contacting the precursor powder with the energy source results in solidifying the precursor powder to consolidate the alloy structure, such that the alloy structure has a hardness of greater than or equal to 140 HV to less than or equal to 200 HV, an estimated hot crack susceptibility coefficient of less than or equal to about 0.3, and a density of greater than or equal to 99.2%.

In embodiments, there is provided an alloy which can include about 4 wt. % to about 8 wt. % copper, about 8 wt. % to about 11 wt. % silicon, and about 75 wt. % to about 88 wt. % aluminum, wherein the alloy has a hardness of about 140 HV to about 200 HV, an estimated hot crack susceptibility coefficient of about 0.3 or less, and a density of about 99.5% or greater. The alloy may be formed by any of the methods or embodiments described herein.

In embodiments, the alloy can further include greater than or equal to about 0.01 wt. % to less than or equal to about 0.8 wt. % iron. In embodiments, the alloy can further include greater than or equal to less than or equal to about 0.01 wt. % to about 0.6 wt. % manganese. In embodiments, the alloy can further include greater than or equal to about 0.01 wt. % to less than or equal to about 0.3 wt. % titanium. In embodiments, the alloy can further include greater than or equal to about 0.01 wt. % to less than or equal to about 0.6 wt. % magnesium. In embodiments, the alloy can further include greater than or equal to about 0.01 wt. % to less than or equal to about 0.8 wt. % iron, greater than or equal to about 0.01 wt. % to less than or equal to about 0.6 wt. % magnesium, greater than or equal to less than or equal to about 0.01 wt. % to about 0.6 wt. % manganese, greater than or equal to about 0.01 wt. % to less than or equal to about 0.3 wt. % titanium, or any combination thereof.

In embodiments, the alloy can include about 4 wt. %, about 4.5 wt. %, about 5 wt. %, about 5.5 wt. %, about 6 wt. %, about 6.5 wt. %, about 7 wt. %, about 7.5 wt. %, about 8 wt. % copper, or any value contained within a range formed by any two of the preceding values.

In embodiments, the alloy can include about 8 wt. %, about 8.5 wt. %, about 9 wt. %, about 9.5 wt. %, about 10 wt. %, about 10.5 wt. %, about 11 wt. % silicon, or any value contained within a range formed by any two of the preceding values.

In embodiments, the alloy can include about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. % iron, or any value contained within a range formed by any two of the preceding values. In embodiments, the alloy does not include iron.

In embodiments, the alloy can include about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % manganese, or any value contained within a range formed by any two of the preceding values. In embodiments, the alloy does not include manganese.

In embodiments, the alloy can include about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.1 wt. %, about 0.2 wt. %, about 0.3 wt. %, about 0.4 wt. %, about 0.5 wt. %, about 0.6 wt. % magnesium, or any value contained within a range formed by any two of the preceding values. In embodiments, the alloy does not include magnesium.

In embodiments, the alloy can include about 0.01 wt. %, about 0.02 wt. %, about 0.03 wt. %, about 0.04 wt. %, about 0.05 wt. %, about 0.1 wt. %, about 0.15 wt. %, about 0.2 wt. %, about 0.25 wt. %, about 0.3 wt. % titanium, or any value contained within a range formed by any two of the preceding values. In embodiments, the alloy does not include titanium.

In embodiments, the alloy includes about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. % aluminum, or any value contained within a range formed by any two of the preceding values. The alloy may include any amounts of copper, silicon, iron, manganese, magnesium, titanium, and aluminum as disclosed herein, such that the total wt. % of each component in the alloy equals 100 wt. %.

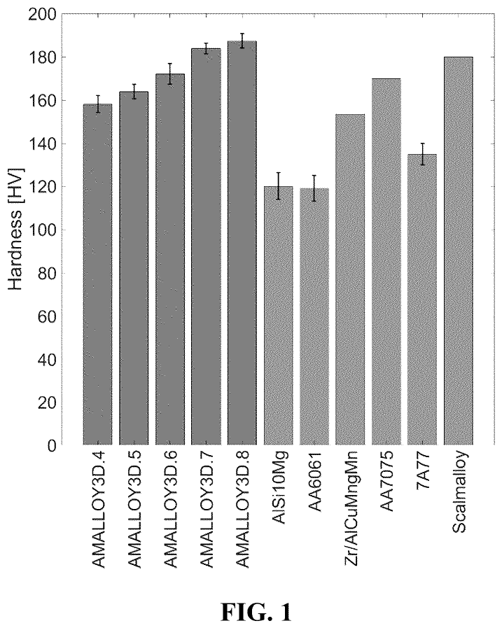

In embodiments, the alloy can have a hardness of greater than or equal to about 140 HV to about 200 HV, such as about 140 HV, about 150 HV, about 160 HV, about 170 HV, about 180 HV, about 190 HV, about 200 HV, or any value contained within a range formed by any two of the preceding values. FIG. 1 is a bar graph of the hardness (HV) of various alloy compositions of the present disclosure compared to commercial alloys.

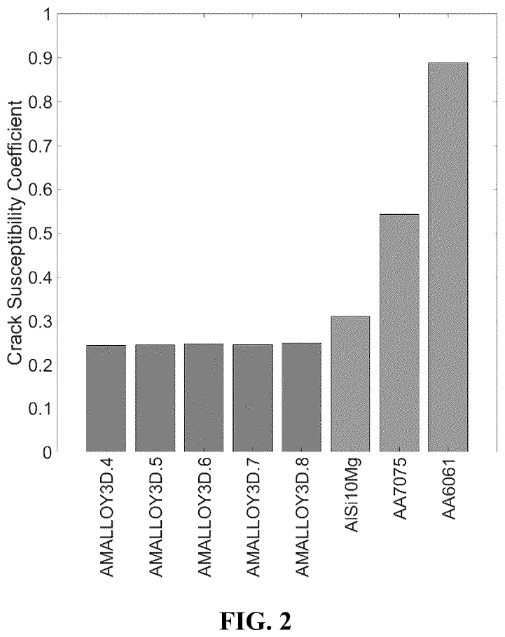

In embodiments, alloys can be characterized based on susceptibility to hot cracking, as would be familiar to one skilled in the art. In embodiments, the alloy can have a hot crack susceptibility coefficient of less than or equal to about 0.3, such as about 0.3, about 0.25, about 0.2, about 0.15, about 0.1, about 0.05, about 0.01, and so forth, or any value contained within a range formed by any two of the preceding values. FIG. 2 is a bar graph showing the hot crack susceptibility coefficient of various alloy compositions of the present disclosure compared to commercial alloys.

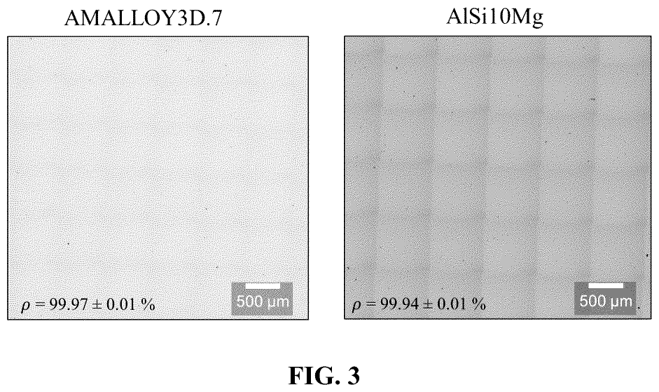

In embodiments, the alloy can have a density of greater than or equal to about 99.5%. For example, in embodiments, the alloy can have a density of about 99.5%, about 99.6%, about 99.7%, about 99.8%, about 99.9%, about 99.95%, about 99.96%, about 99.97%, about 99.98%, about 99.99%, up to 100%, or any value contained within a range formed by any two of the preceding values. FIG. 3 shows micrographs of an alloy of the present disclosure in its as-printed state compared to a commercially available AlSi10Mg alloy. The cross-sectional micrographs in FIG. 3 are of cuboids having dimensions of 10 mm×10 mm×10 mm that were cut off along the building direction from larger parts of the as-printed material. According to the relative densities achieved after the PBF-LB process, the alloy of the present disclosure reached a higher density than the commercial AlSi10Mg alloy. This is shown in FIG. 3 as there are fewer macroscopic pores or ridges in micrograph for the alloy of the present disclosure as compared to that of AlSi10Mg.

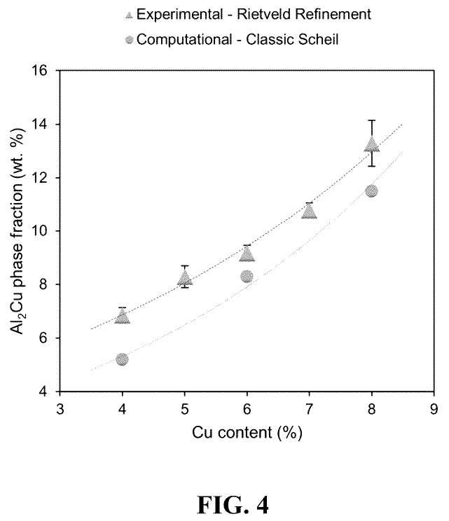

In embodiments, the alloy has an Al₂Cu phase fraction of about y wt. %, wherein y=0.2052.x²−0.924x+7.4253, wherein x=Cu wt. %. This relationship is shown in FIG. 4, which is a graph of Al₂Cu phase fraction (wt. %) vs. Cu content (wt. %). As shown in FIG. 4, the Al₂Cu phase fraction increases with copper content. The experimentally obtained data is well-correlated with the computationally predicted data, as shown in FIG. 4.

In embodiments, the alloy may have a yield strength (YS) of greater than or equal to about 200 MPa to less than or equal to about 350 MPa. For example, in embodiments, the alloy has a yield strength of about 200 MPa, about 250 MPa, about 300 MPa, about 350 MPa, or any value contained within a range formed by any two of the preceding values.

In embodiments, the alloy may have an ultimate tensile strength (UTS) of about greater than or equal to 350 MPa to less than or equal to about 500 MPa. For example, in embodiments, the alloy may have an ultimate tensile strength of about 350 MPa, about 400 MPa, about 450 MPa, about 500 MPa, or any value contained within a range formed by any two of the preceding values.

In embodiments, the alloy may have an elongation at failure of greater than or equal to about 3% to less than or equal to about 15%, such as about 3%, about 4%, about 5%, about 6%, about 7%, about 8%, about 9%, about 10%, about 11%, about 12%, about 13%, about 14%, about 15%, or any value contained within a range formed by any two of the preceding values.

The embodiments disclosed herein may be combined in any manner to form new embodiments. For example, the methods or combinations of methods disclosed herein may be used to produce the alloys disclosed herein.

The present disclosure includes the following non-limiting embodiments.
1. A method for forming a three-dimensional article comprising an alloy, the method comprising steps of: depositing a first layer of a precursor powder onto a build platform, wherein the precursor powder comprises aluminum, silicon, and copper; contacting the first layer of the precursor powder with an energy source to form a solid layer of the alloy; depositing a subsequent layer of the precursor powder on top of the solid layer; and contacting the subsequent layer of the precursor powder with the energy source to fuse the subsequent layer of the precursor powder to the solid layer; thereby forming the three-dimensional article.
2. The method of embodiment 1, wherein the precursor powder comprises greater than or equal to 4 wt. % to less than or equal to 8 wt. % copper.
3. The method of embodiment 1 or 2, wherein the precursor powder comprises: greater than or equal to 4 wt. % to less than or equal to 8 wt. % copper, and greater than or equal to 8 wt. % to less than or equal to 11 wt. % silicon.
4. The method of any of embodiments 1-3, wherein the precursor powder comprises: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum.
5. The method of any of embodiments 1-4, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, and greater than or equal to 75 wt. % to less than or equal to 88 wt. % aluminum.
6. The method of any of embodiments 1-5, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.6 wt. % manganese, and greater than or equal to 75 wt. % to less than or equal to 88 wt. % aluminum.
7. The method of any of embodiments 1-6, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.6 wt. % magnesium, and greater than or equal to 75 wt. % to less than or equal to 88 wt. % aluminum.
8. The method of any of embodiments 1-7, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.3 wt. % titanium, and greater than or equal to 75 wt. % to less than or equal to 88 wt. % aluminum.
9. The method of any of embodiments 1-8, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.
10. The method of any of embodiments 1-9, further comprising preparing the precursor powder, wherein preparing the precursor powder comprises combining a copper-containing powder with a silicon-containing powder.
11. The method of any of embodiments 1-10, further comprising preparing the precursor powder, wherein preparing the precursor powder comprises combining an elemental copper powder with a pre-alloyed powder comprising silicon, aluminum, magnesium, or combinations thereof.
12. The method of any of embodiments 1-11, further comprising preparing the precursor powder, wherein preparing the precursor powder comprises sizing the precursor powder to an average particle size of greater than or equal to 1 μm to less than or equal to 100 μm.
13. The method of any of embodiments 1-12, further comprising preparing the precursor powder, wherein preparing the precursor powder comprises sizing the precursor powder to a particle size distribution of 1 μm to 100 μm.
14. The method of any of embodiments 1-13, further comprising preparing the precursor powder, wherein preparing the precursor powder comprises sizing the precursor powder via vibratory sieving.
15. The method of any of embodiments 1-14, further comprising preparing the precursor powder, wherein preparing the precursor powder comprises ultrasonic atomization.
16. The method of any of embodiments 1-15, further comprising (e) repeating steps (c) through (d) a plurality of times.
17. The method of any of embodiments 1-16, wherein the three-dimensional article has a density of greater than or equal to 99.2%.
18. The method of any of embodiments 1-17, wherein the three-dimensional article has a density of greater than or equal to 99.5%.
19. The method of any of embodiments 1-18, wherein the three-dimensional article has a density of greater than or equal to 99.9%.
20. The method of any of embodiments 1-19, wherein the alloy has a hardness of greater than or equal to 140 HV to 200 HV, a hot crack susceptibility coefficient of less than or equal to 0.3, and a density of 99.2% or greater.
21. A method for producing an alloy structure having a density of greater than or equal to 99.2%, comprising: providing a precursor powder comprising greater than or equal to 4 wt. % to less than or equal to 8 wt. % copper to an additive manufacturing system; and contacting the precursor powder with an energy source to form the alloy structure.
22. The method of embodiment 21, wherein the precursor powder comprises: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum.
23. The method of embodiment 21 or 22, wherein the precursor powder comprises: greater than or equal to 4 wt. % to less than or equal to 8 wt. % copper, greater than or equal to 8 wt. % to less than or equal to 11 wt. % silicon, greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, greater than or equal to 0.01 wt. % to less than or equal to 0.3 wt. % titanium, and greater than or equal to 75 wt. % to less than or equal to 88 wt. % aluminum.
24. The method of any of embodiments 21-23, wherein the precursor powder comprises a mixture of a copper-containing powder and a silicon-containing powder.
25. The method of any of embodiments 21-24, wherein the precursor powder is sized via vibratory sieving prior to contacting the precursor powder with an energy source.
26. The method of any of embodiments 21-25, wherein the precursor powder is sized to an average particle size of greater than or equal to 1 μm to less than or equal to 100 μm prior to contacting the precursor powder with the energy source.
27. The method of any of embodiments 21-26, wherein the precursor powder has a particle size distribution of 1 μm to 100 μm.
28. The method of any of embodiments 21-27, wherein providing the precursor powder comprises depositing the precursor powder onto a build plate, wherein the build plate is at a temperature of greater than or equal to 100° C. to less than or equal to 300° C.
29. The method of any of embodiments 21-28, wherein contacting the precursor powder with the energy source results in fusing the precursor powder to consolidate the alloy structure, such that the alloy structure has a density of greater than or equal to 99.2%.
30. The method of any of embodiments 21-29, wherein contacting the precursor powder with the energy source results in fusing the precursor powder to consolidate the alloy structure, such that the alloy structure has a density of greater than or equal to 99.5%.
31. The method of any of embodiments 21-30, wherein contacting the precursor powder with the energy source results in fusing the precursor powder to consolidate the alloy structure, such that the alloy structure has a density of greater than or equal to 99.9%.
32. The method of any of embodiments 21-31, wherein contacting the precursor powder with the energy source results in fusing the precursor powder to consolidate the alloy structure, such that the alloy structure has a hardness of greater than or equal to 140 HV to less than or equal to 200 HV, a hot crack susceptibility coefficient of less than or equal to 0.3, and a density of greater than or equal to 99.5%.
33. An alloy, comprising: greater than or equal to 4 wt. % to less than or equal to 8 wt. % copper, greater than or equal to 8 wt. % to less than or equal to 11 wt. % silicon, and greater than or equal to 75 wt. % to less than or equal to 88 wt. % aluminum, wherein the alloy has a hardness of greater than or equal to 140 HV to less than or equal to 200 HV, a hot crack susceptibility coefficient of less than or equal to 0.3, and a density of greater than or equal to 99.5%.
34. The alloy of embodiment 33, comprising greater than or equal to 5 wt. % to less than or equal to 7 wt. % copper.
35. The alloy of embodiment 33 or 34, comprising 7 wt. % copper.
36. The alloy of any of embodiments 33-35, further comprising greater than or equal to 0.01 wt. % to less than or equal to 0.8 wt. % iron.
37. The alloy of any of embodiments 33-36, further comprising greater than or equal to 0.01 wt. % to less than or equal to 0.6 wt. % manganese.
38. The alloy of any of embodiments 33-37, further comprising greater than or equal to 0.01 wt. % to less than or equal to 0.6 wt. % magnesium.
39. The alloy of any of embodiments 33-38, further comprising greater than or equal to 0.01 wt. % to less than or equal to 0.3 wt. % titanium.
40. The alloy of any of embodiments 33-39, further comprising greater than or equal to 0.01 wt. % to less than or equal to 0.8 wt. % iron, greater than or equal to 0.01 wt. % to less than or equal to 0.6 wt. % manganese, greater than or equal to 0.01 wt. % to less than or equal to 0.6 wt. % magnesium, and greater than or equal to 0.01 wt. % to less than or equal to 0.3 wt. % titanium.
41. The alloy of any of embodiments 33-40, wherein the alloy has a density of greater than or equal to 99.9%.
42. The alloy of any of embodiments 33-41, wherein the alloy has an Al2Cu phase fraction of y wt. %, wherein y=0.2052x2-0.924x+7.4253, and wherein x=Cu wt. %.
43. The alloy of any of embodiments 33-42, wherein the alloy has a yield strength of greater than or equal to 200 MPa to less than or equal to 350 MPa.
44. The alloy of any of embodiments 33-43, wherein the alloy has an ultimate tensile strength of greater than or equal to 350 MPa to less than or equal to 500 MPa.
45. The alloy of any of embodiments 33-44, wherein the alloy has an elongation at failure of greater than or equal to 3% to less than or equal to 15%.

### EXAMPLES

### Example 1

High-strength aluminum alloys containing copper as described herein were prepared according to an embodiment of the present disclosure. The alloy development process was carried out using an integrated computational-experimental method that enabled a fast screening of possible alloys' compositions for metal additive manufacturing. The CALPHAD approach using Thermo-Calc2023b software, and an updated Al-based Alloy Database (TCAL8) was applied for computational predictions. The particle size distribution of the precursor powder which included elemental copper powder and pre-alloyed AlSi10Mg powder was D10=26.8 μm, D50=41.8 μm, and D90=64.7 μm, as determined by laser diffraction.

The articles printed with the compositions of the present disclosure can be used in several industrial sectors, such as space, aerospace/aviation, and energy. These materials can replace the existing high-strength aluminum alloys for end-use cases requiring light weight combined with high strength.

TABLE 1

| | Si | Cu | Fe | Mn | Mg | Ti | |
|---|---|---|---|---|---|---|---|
| Sample | (wt. %) | (wt. %) | (wt. %) | (wt. %) | (wt. %) | (wt. %) | Al |
| 1 | 9.6 | 4 | 0.53 | 0.43 | 0.43 | 0.14 | Bal. |
| 2 | 9.5 | 5 | 0.52 | 0.43 | 0.43 | 0.14 | Bal. |
| 3 | 9.4 | 6 | 0.52 | 0.42 | 0.42 | 0.14 | Bal. |
| 4 | 9.3 | 7 | 0.51 | 0.42 | 0.42 | 0.14 | Bal. |
| 5 | 9.2 | 8 | 0.51 | 0.41 | 0.41 | 0.14 | Bal. |

TABLE 1 shows the composition of five alloy samples (also referred to herein as “coupons”), according to embodiments of the present disclosure. Aluminum content of “Bal.” means that the remainder of the alloy composition is aluminum, such that the total wt. % of the alloy composition equals 100 wt. %.

The hardness of the newly developed alloys of the present disclosure was measured in the top layer of master alloy samples manufactured via arc-melting manufacturing after a single laser exposure in a PBF-LB printer. The master samples have the same chemical compositions of the alloys of the present disclosure defined in TABLE 1. The solidification conditions during laser scanning resembled those reached in the PBF-LB process. As can be seen in FIG. 1, the hardness of alloys of the present disclosure stands above the commercial AlSi10Mg alloy's counterpart. The increase in hardness was 31% to a maximum of 56% based on the addition of Cu. The hardness range of these new grades, 120-187 HV, is comparable to, or even higher than, that of the commercial high-strength aluminum alloys available in the market.

To assess the printability of the alloys of the present disclosure, the hot crack susceptibility of each alloy grade was estimated by using the crack susceptibility coefficient (CSC) proposed by Clyne and Davies using the Thermo-Calc 2023b software. The data reported in FIG. 2 demonstrates that the alloys of the present disclosure have lower CSC and are thus less prone to hot cracking phenomena than the high strength commercially available Al alloys evaluated, including AA7075 and AA6061, which are known in the art as being sensitive to hot cracking. In addition, the CSC values of the alloys of the present disclosure are lower than that of an AlSi10Mg alloy, which, without wishing to be bound by theory, is generally indicative of excellent printability in the PBF-LB process without incurring cracking defects.

The alloy compositions of the present example were formed in-situ by leveraging the PBF-LB process for the actual chemical alloying of AlSi10Mg and Cu powders (‘in-situ alloying’ process). Studies were conducted to print near-fully dense parts reaching a density level of 99.97±0.01%, evidencing the good printability of the new alloy. The process parameters used to form the alloys using an AconityMIDI+ PBF-LB printer is summarized in TABLE 2.

TABLE 2
Parameter sets

| General | | | Hatch | | | Contour | | |
|---|---|---|---|---|---|---|---|---|
| Spot size | 90 | μm | Power | 380 | W | Power | 400 | W |
| Layer | 50 | μm | Hatch | 150 | μm | Contour | 120 | μm |

| thickness | | distance | | | distance | | |
|---|---|---|---|---|---|---|---|
| Scan | Stripe | Scan | 1350 | mm/s | Scan | 2000 | mm/s |

| strategy | hatching | | speed | | | Speed | |
|---|---|---|---|---|---|---|---|
| Build plate | 220° | C. | Stripe | 5 | mm | Contour | 2 |

| | | |
|---|---|---|
| temperature | width | Count |

As shown in FIG. 3, the relative density of the alloy of the present disclosure was comparable to and even exceeded that of the commercially available AlSi10Mg alloy, meaning that the Cu addition did not negatively compromise the alloy's printability. The minor content of porosity in the alloy coupons (0.03%) was attributed to the formation of gas pores during PBF-LB printing, without wishing to be bound by theory. Therefore, using the parameters of TABLE 2, typical processability defects, such as lack of fusion areas and keyhole pores, can be reduced. It is contemplated that other parameters may also be suitable for achieving the results described herein. Other parameters may be necessary when using other printing systems and the above parameters should not be considered limiting. The alloy of the present disclosure did not reveal any tendencies of hot cracking, thus corroborating the low cracking propensities of present alloy grades, as predicted by the Clyne and Davies model.

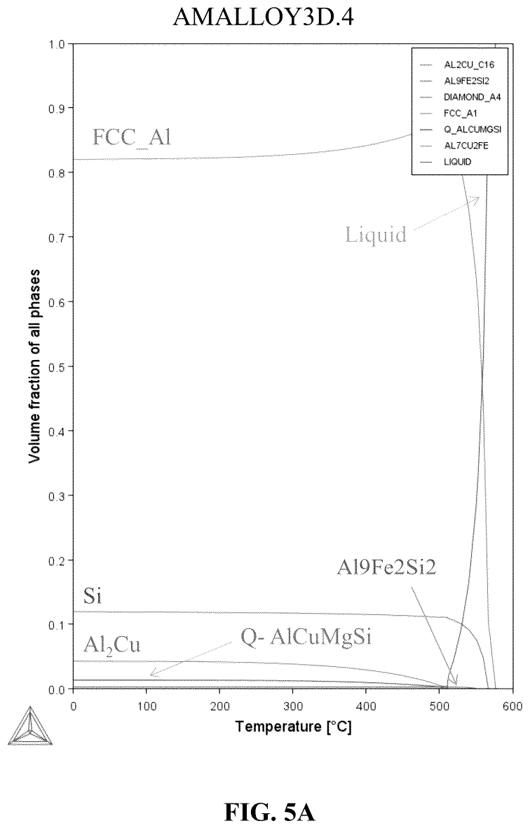

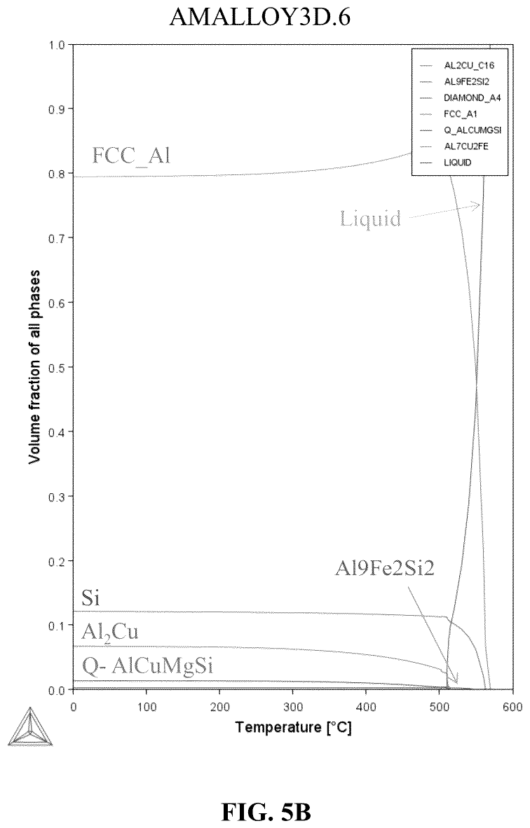

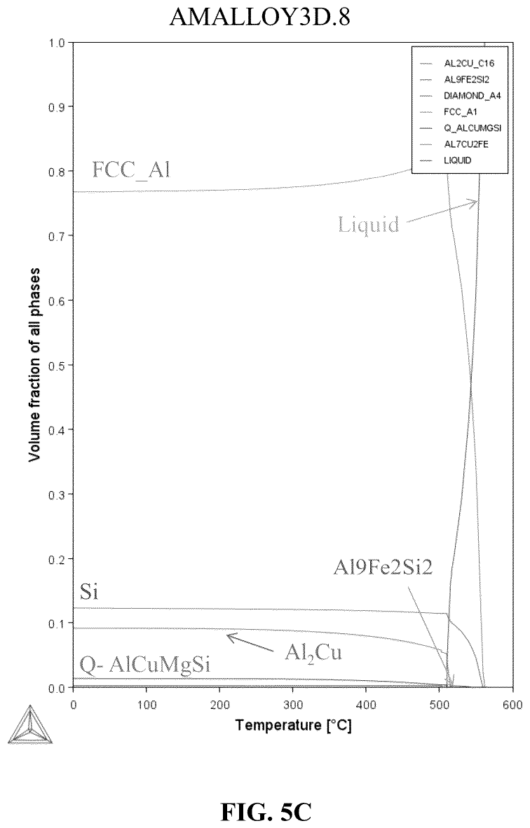

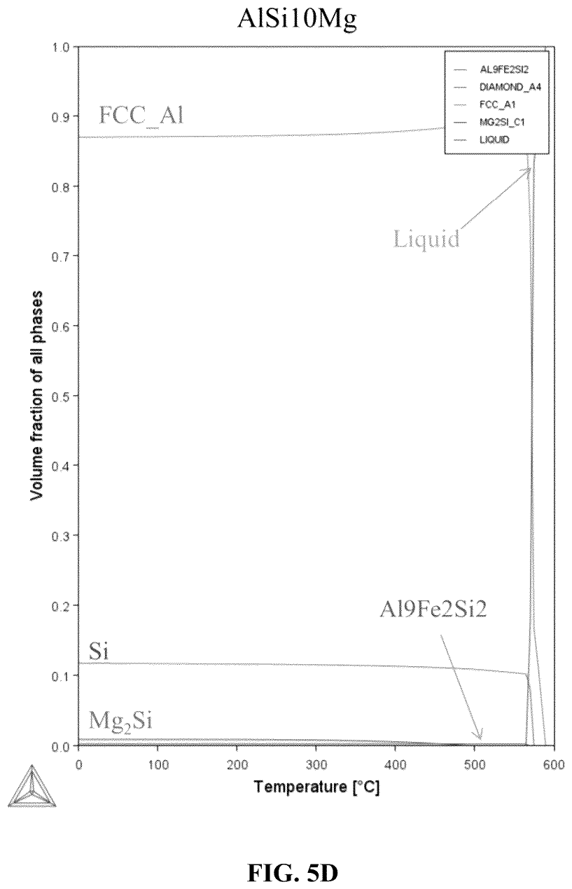

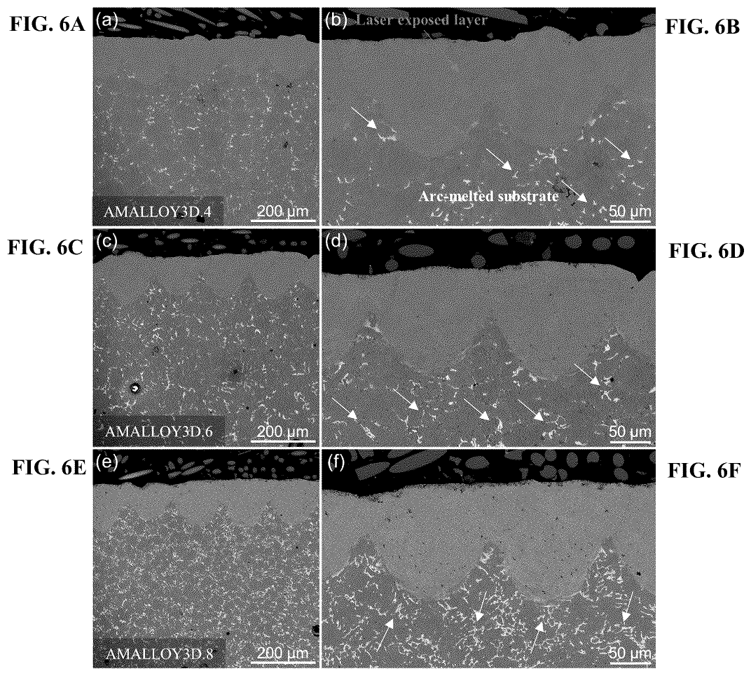

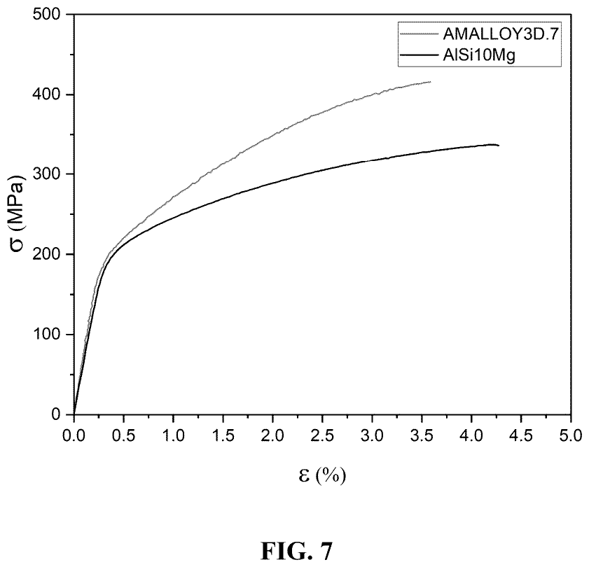

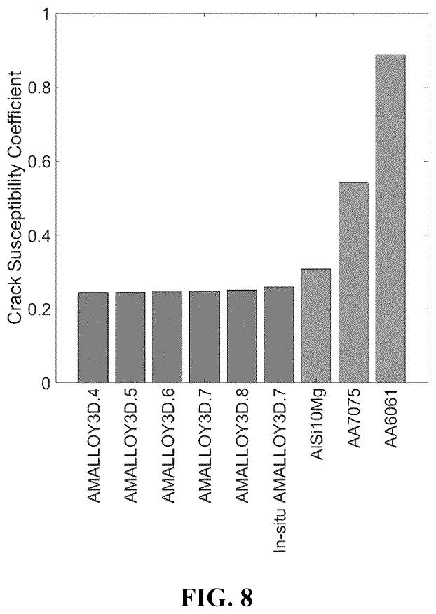

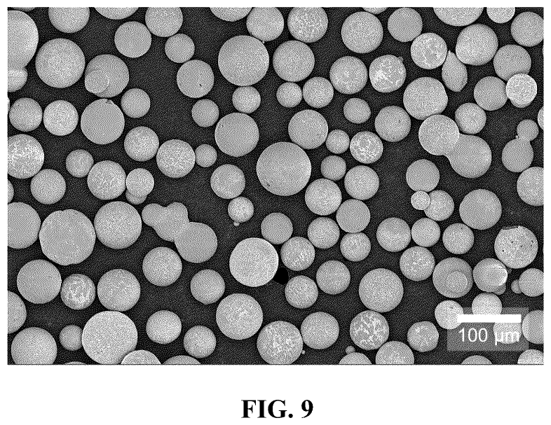

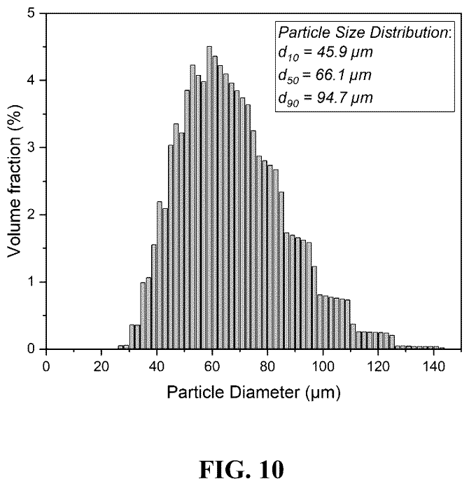

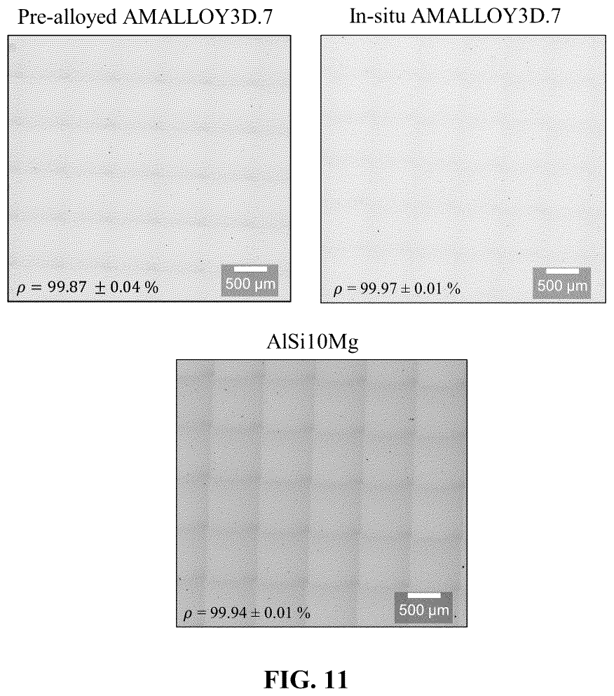

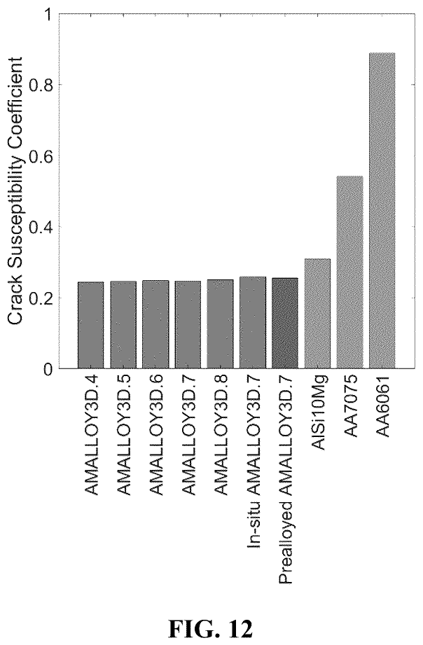

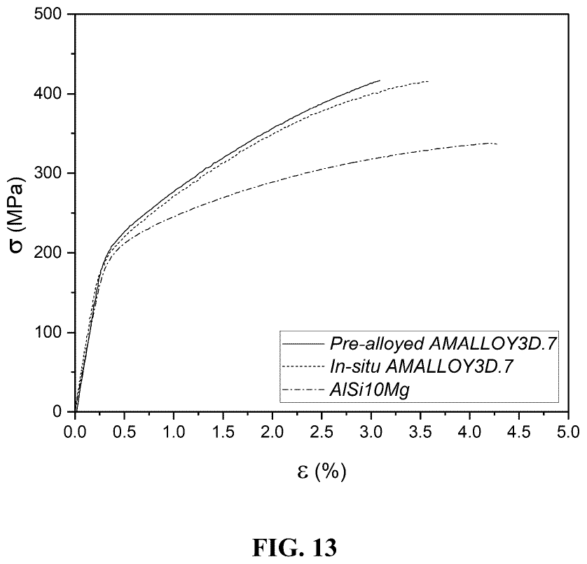

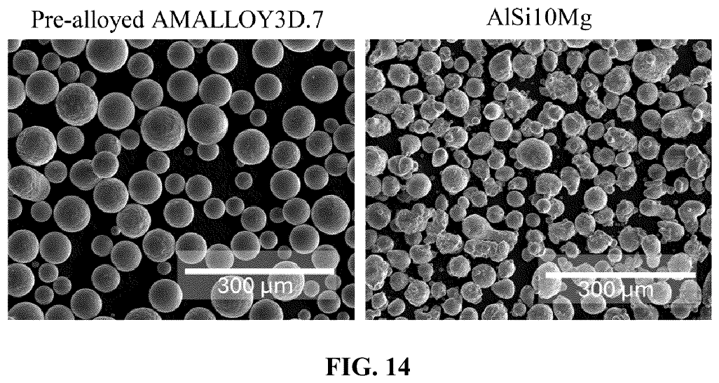

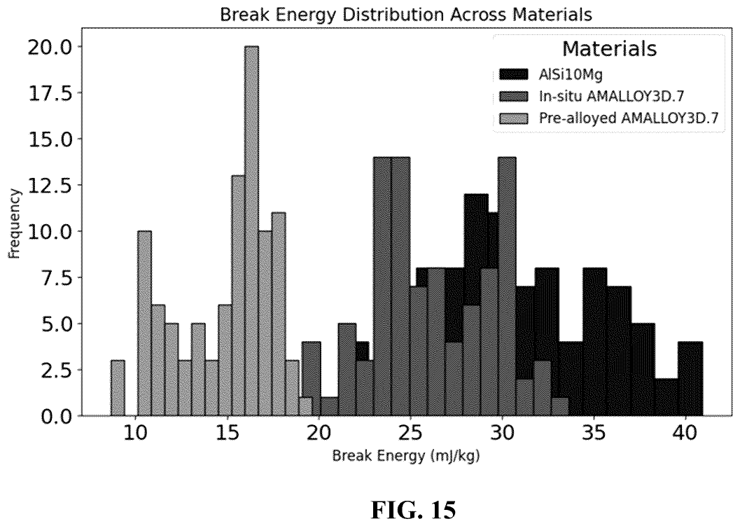

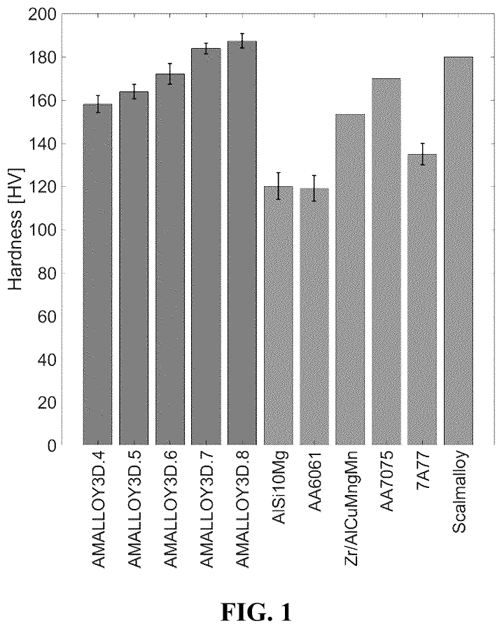

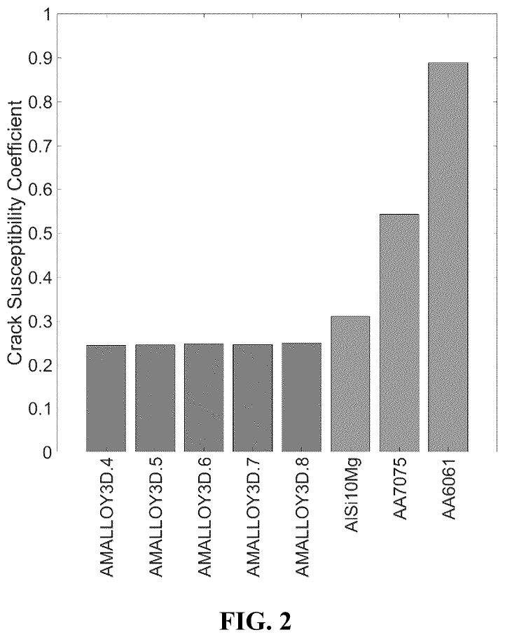

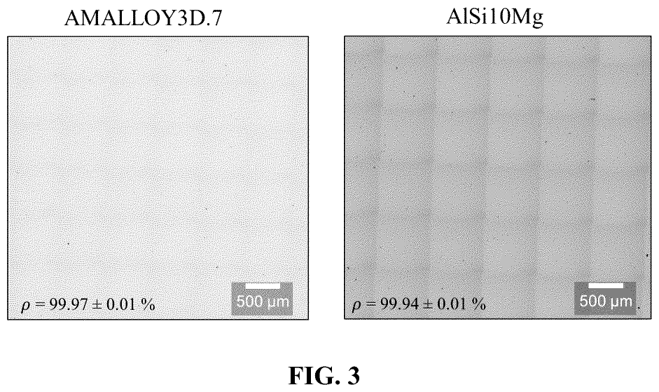

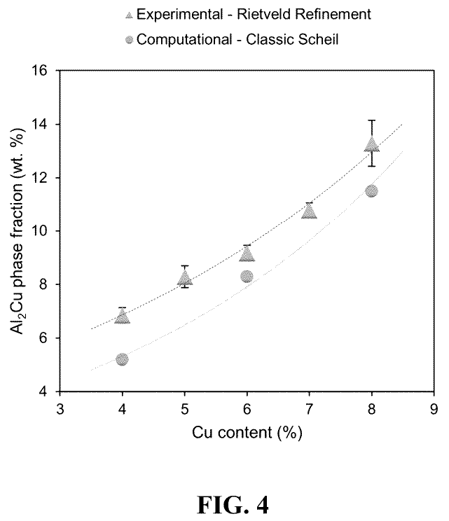

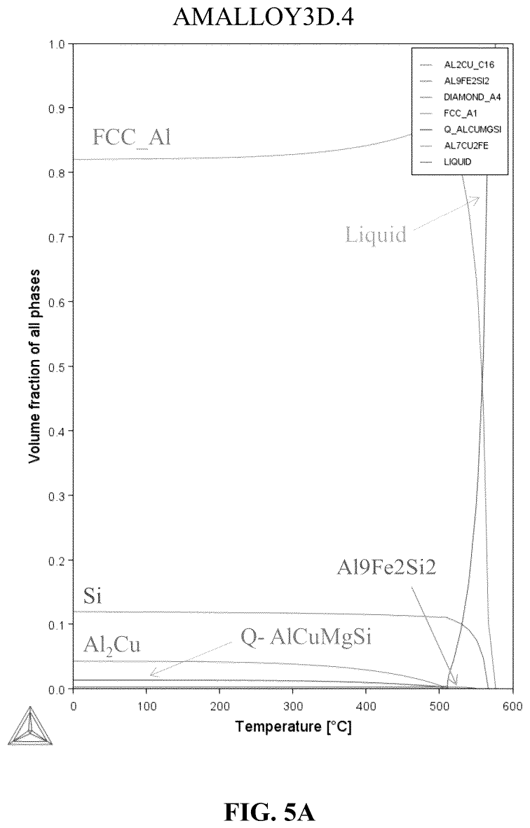

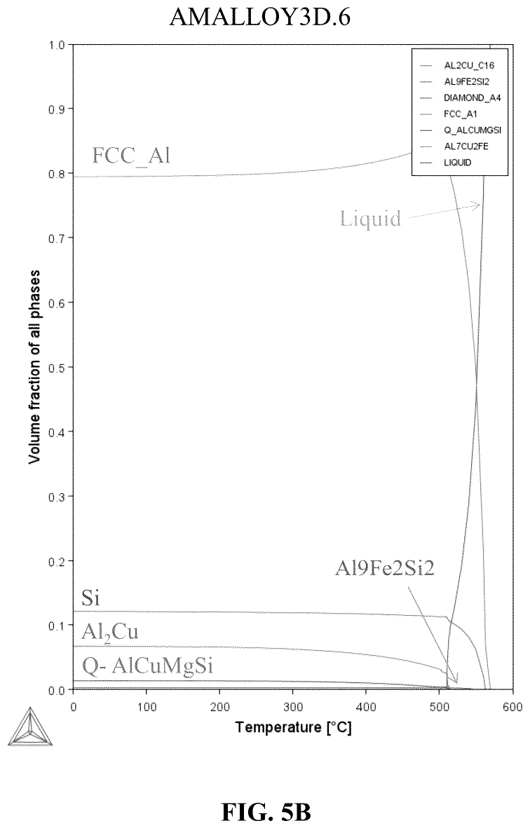

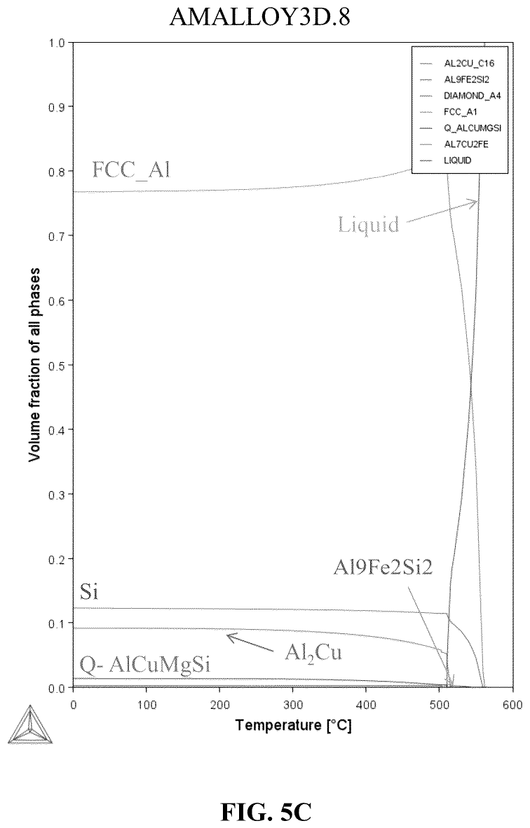

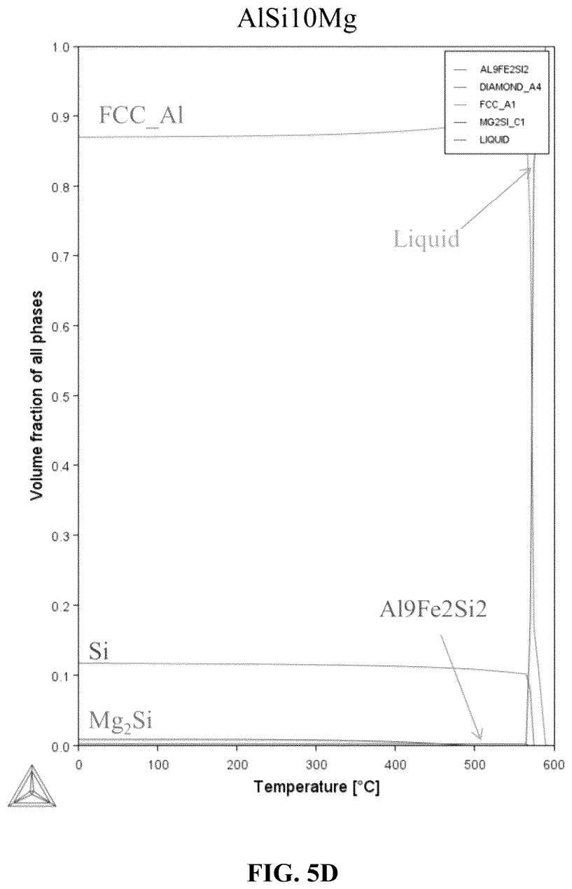

The evolution of metallurgical phases following equilibrium conditions in the present alloys featuring 4 wt. %, 6 wt. %, and 8 wt. % copper is depicted in FIGS. 5A, 5B, and 5C. FIG. 5A shows the temperature vs. volume fraction of all phases for an alloy of the present disclosure having 4 wt. % copper, FIG. 5B shows the temperature vs. volume fraction of all phases for an alloy of the present disclosure having 6 wt. % copper, FIG. 5C shows the temperature vs. volume fraction of all phases for an alloy of the present disclosure having 8 wt. % copper, and FIG. 5D shows the temperature vs. volume fraction of all phases for a commercially available AlSi10Mg alloy. The presence of Cu in the alloy grades of the present disclosure induces the precipitation of Cu-reinforcing phases, such as θ-A12Cu, Q-AlCuMgSi, and A17Cu2Fe, which are not found in the Cu-free commercially available AlSi10Mg alloy. As a result, the strength of the present alloy grades may be significantly enhanced compared to the commercially available AlSi10Mg alloy due to the additional presence of Cu that simultaneously exploits solid solution, precipitation, and grain refinement strengthening mechanisms, without wishing to be bound by theory.

Also investigated was the production of alloys with Cu content ranging from 4 wt. % to 8 wt. %, in 1% increments, through arc melting manufacturing. The surface of each produced coupon was subsequently exposed to the laser source of an industrial PBF-LB system (Renishaw AM 400) to assess the effects of rapid solidification on the alloys' microstructure and hardness. The experiments mimicked the microstructure that is formed when processing by PBF-LB. The laser surface scanning was conducted on the master alloy coupons' surface directly, that is, without using pre-alloyed and/or elemental powder media. The following PBF-LB parameters were used to expose the arc-melted coupons: laser power of 400 W, point distance of 27 μm, exposure time of 20 μm, and hatch distance of 150 μm. The experimental results from Scanning Electron Microscopy (SEM), X-Ray Diffraction (XRD), and Vickers hardness (HV) analyses on samples with increased content of copper were correlated with the computational predictions using CALPHAD approach. The experimental parameters for SEM, XRD, and Vickers hardness analyses followed standard procedure for each measurement and could be replicated by one skilled in the art.

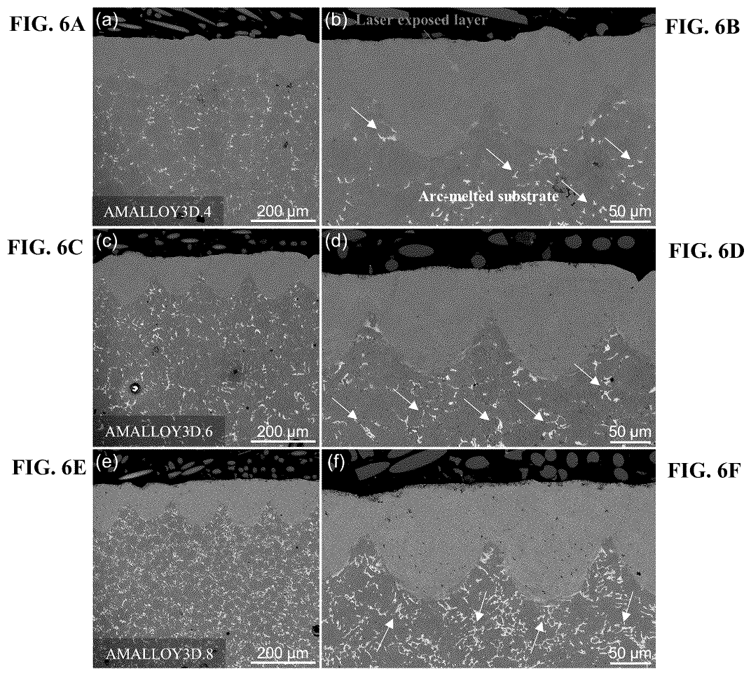

FIGS. 6A-6F each show an overview of the microstructures of alloys of the present disclosure. FIG. 6A shows the microstructure of an alloy with a Cu content of 4 wt. % at 200 μm scale and FIG. 6B shows the same alloy at 50 μm scale. FIG. 6C shows the microstructure of an alloy with a Cu content of 6 wt. % at 200 μm scale and FIG. 6D shows the same alloy at 50 μm scale. FIG. 6E shows the microstructure of an alloy with a Cu content of 8 wt. % at 200 μm scale and FIG. 6F shows the same alloy at 50 μm scale. It is possible to observe a microstructural transition when moving from the arc-melted substrate into the exposed top layer (see, for instance, FIG. 6B) due to the extreme refinement of the dendritic-cellular structures induced by the high cooling rate of the PBF-LB process. This refinement allows identification of the exposed top layer from the arc-melted substrate. In the remelted layers (FIGS. 6B, 6D, 6F), there were no traces of coarse Cu-rich compounds, and it is contemplated that the copper largely dissolved in the aluminum matrix. A close examination of the microstructures in the arc-melted substrates revealed the presence of brighter polygonal features identified as Cu-rich compounds (see white arrows in FIGS. 6A-6F). The occurrence of such Cu compounds increased with the progressive addition of Cu, as shown when comparing FIG. 6B to FIG. 6F.

The identification and quantification of Cu-rich phases in the laser exposed layer (the top-most layer) was conducted via XRD using the Rietveld refinement method for data post-processing. This relationship is shown in FIG. 4, which is a graph of Al₂Cu phase fraction (wt. %) vs. Cu content (wt. %) of an alloy of the present disclosure. θ-Al₂Cu was the primary Cu-bearing phase observed and its content progressively increased with the Cu addition in-line with the phase fraction estimation from CALPHAD with ‘Classic Scheil’ assumption. Q-AlCuMgSi phase was not detected, likely due to its fine size and quantity. Higher content of θ-Al₂Cu may promote the alloy's hardness and strength through the precipitation strengthening mechanism, without wishing to be bound by theory.

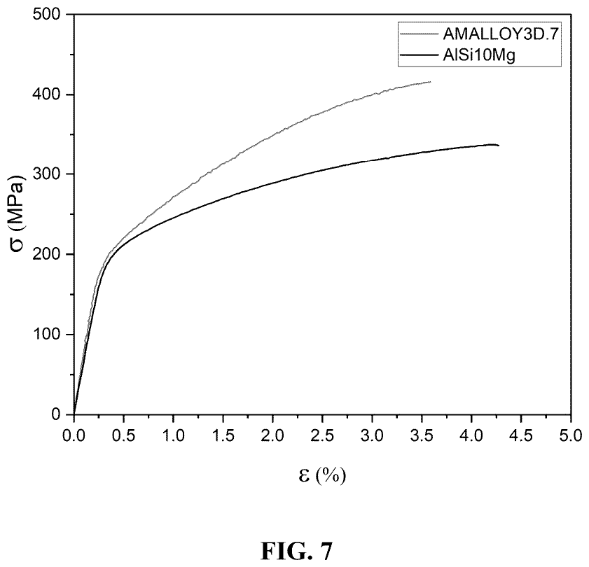

The results of tensile tests conducted on the as-built alloy of the present disclosure having 7 wt. % copper are summarized in FIG. 7 and TABLE 3. FIG. 7 is a graph of stress-strain tensile curves of the as-built alloy of the present disclosure having 7 wt. % copper and a commercially available AlSi10Mg alloy processed at 220° C. for 12 hours. TABLE 3 shows the tensile properties of an alloy of the present disclosure having 7 wt. % copper printed at 220° C. for 12 hours, compared to a AlSi10Mg processed using the same build plate temperature and printing time. As shown in TABLE 3, the alloy having 7 wt. % copper shows yield strength (YS) and ultimate tensile strength (UTS) which are higher than the AlSi10Mg counterpart, with an increase of 33% and 27%, respectively. The highly supersaturated solid solution of Cu and Si atoms in the fcc-Al phase and the precipitation of Al₂Cu compounds (as shown in FIG. 4) are thought to be the major strengthening contributions for alloys of the present disclosure. In addition, the elongation at failure (¿) of the 7 wt. % copper alloy was not depleted by the Cu strengthening, as the value was comparable to the AlSi10Mg's ductility.

TABLE 3

| Alloy | YS (MPa) | UTS (MPa) | ε (%) |
|---|---|---|---|
| AMALLOY3D.7 | 219.9 ± 11.8 | 418 ± 18.2 | 3.6 ± 0.4 |
| AlSi10Mg | 165.6 ± 5.1 | 329.3 ± 4.6 | 3.7 ± 0.2 |

### Example 2

Further high-strength aluminum alloys containing copper as described herein were prepared according to an embodiment of the present disclosure. The compositions of these alloys are shown in TABLE 4.

TABLE 4

| | Si | Cu | Fe | Mn | Mg | Ti | |
|---|---|---|---|---|---|---|---|
| Sample | (wt. %) | (wt. %) | (wt. %) | (wt. %) | (wt. %) | (wt. %) | Al |
| 6 | 8.19 | 7.27 | 0.13 | <0.02 | 0.31 | <0.02 | Bal. |
| 7 | 8.56 | 7.41 | 0.12 | <0.02 | 0.28 | <0.02 | Bal. |

Samples 6 and 7 are an in-situ powder blend and an as-built alloy coupon, respectively. To assess the printability of the alloys of the present disclosure, the hot cracking susceptibility of each alloy grade was estimated by using the crack susceptibility coefficient (CSC) proposed by Cline and Davies using the Thermo-Calc 2023b software. In Example 1, the theoretical chemical formulations of the investigated AMALLOY3D grades were used to inform the CALPHAD computation for CSC prediction. In this example, however, the chemical composition of a powder mixture having AlSi10Mg and Cu in a weight proportion (wt. %) of 93:7 was measured by Inductively Coupled Plasma Optical Emission Spectroscopy (ICP-OES) as shown in TABLE 4. This analysis was used to inform the CALPHAD computation in the prediction of the CSC value for the AMALLOY3D.7 grade before PBF-LB process. It was noted that the chemical compositions of AMALLOY3D.7 coupons were largely consistent with those in the corresponding AMALLOY3D.7 powder mixture, apart from slight fluctuations in some elements.

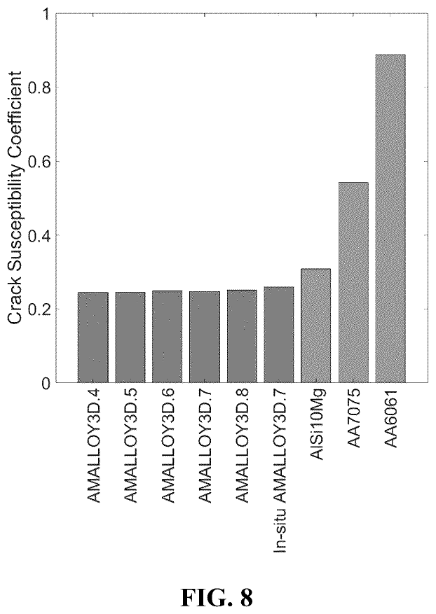

FIG. 8 is a bar graph showing the hot crack susceptibility coefficient of various alloy compositions according to embodiments of the present disclosure compared to commercial grades of aluminum alloys. As shown in FIG. 8, the alloys of the present disclosure have lower CSC and thus are less prone to hot cracking phenomena than the high strength commercially available Al alloys evaluated, including AA7075 and AA6061, which are known in the art as being sensitive to hot cracking. In addition, the CSC values of the alloys of the present disclosure are lower than that of AlSi10Mg alloy, which, without wishing to be bound by theory, is generally indicative of excellent printability in the LPBF-LB process without incurring cracking defects.

### Example 3

In Example 1, the alloy compositions were consolidated in-situ by leveraging the PBF-LB process for the actual chemical alloying of the AlSi10Mg and Cu powder mixture. To assess the printability of the alloys of the present disclosure, the hot cracking susceptibility of each alloy grade was estimated by using the crack susceptibility coefficient (CSC) proposed by Cline and Davies using the Thermo-Calc 2023b software. Previously, the theoretical chemical formulations of the investigated AMALLOY3D grades have been used to inform the CALPHAD computation for CSC prediction. In this example, the chemical compositions of the samples of pre-alloyed AMALLOY3D.7 powder were measured by Inductively Coupled Plasma Optical Emission Spectroscopy (ICP-OES) and, later, the mean values of the chemical elements reported in TABLE 5 were used to inform the CALPHAD computation in the prediction of the CSC value for the AMALLOY3D.7 grade before the PBF-LB process. TABLE 5 shows the chemical composition, measured by ICP-OES, of the pre-alloyed AMALLOY3D.7 powder and coupons produced by PBF-LB using the pre-alloyed powder.

TABLE 5

| | Si | Cu | Fe | Mn | Mg | Ti | O | |
|---|---|---|---|---|---|---|---|---|
| Sample | (wt. %) | (wt. %) | (wt. %) | (wt. %) | (wt. %) | (wt. %) | (wt. %) | Al |
| Pre-alloyed | 9.09 ± | 6.83 ± | 0.11 ± | <0.02 | 0.33 ± | <0.02 | 0.004 ± | Bal. |
| AMALLOY3D.7 | 0.04 | 0.02 | 0 | | 0 | | 0.001 | |
| powder | | | | | | | | |
| Coupons | 9.15 | 6.85 | 0.11 | <0.02 | 0.31 | <0.02 | 0.011 | Bal. |
| produced from | | | | | | | | |
| pre-alloyed | | | | | | | | |
| AMALLOY3D.7 | | | | | | | | |
| powder | | | | | | | | |

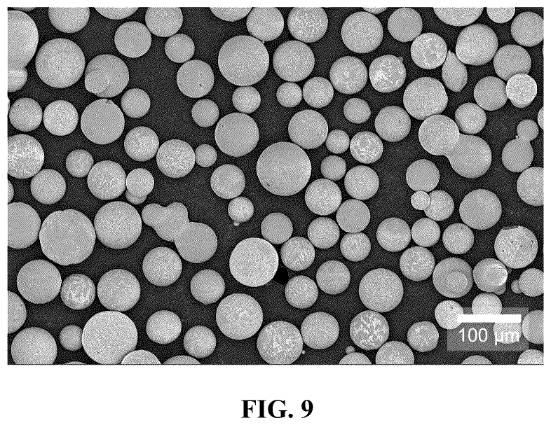

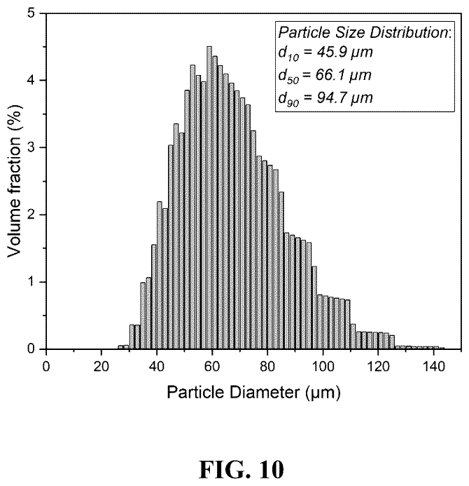

These powders were produced via ultrasonic atomization, aiming to enhance the chemical homogeneity of the as-printed material. FIG. 9 depicts the morphology of pre-alloyed AMALLOY3D.7 powder particles characterized by a high degree of sphericity, according to an embodiment of the present disclosure. FIG. 10 shows the particle size distribution (PSD) of the pre-alloyed AMALLOY3D.7 powders, according to an embodiment of the present disclosure, as measured by laser diffraction before the additive manufacturing process. The PSD of pre-alloyed AMALLOY3D.7 is characterized by a d10, d50, and d90 of 45.9 μm, 66.1 μm, and 94.7 μm, respectively.

Studies were conducted to print near-fully dense parts reaching a density level of 99.87±0.04%, evidencing the good printability of the pre-alloyed AMALLOY3D.7 powder. The process parameters used to form the AMALLOY3D.7 alloy using an AconityMIDI+ PBF-LB printer are summarized in TABLE 6.

TABLE 6
Parameter sets

| General | | | Hatch | | | Contour | | |
|---|---|---|---|---|---|---|---|---|
| Spot size | 90 | μm | Power | 440 | W | Power | 400 | W |
| Layer | 50 | μm | Hatch | 150 | μm | Contour | 120 | μm |

| thickness | | distance | | | distance | | |
|---|---|---|---|---|---|---|---|
| Scan | Stripe | Scan | 1350 | mm/s | Scan | 2000 | mm/s |

| strategy | hatching | | speed | | | Speed | |
|---|---|---|---|---|---|---|---|
| Build plate | 220° | C. | Stripe | 5 | mm | Contour | 2 |

| | | |
|---|---|---|
| temperature | width | Count |

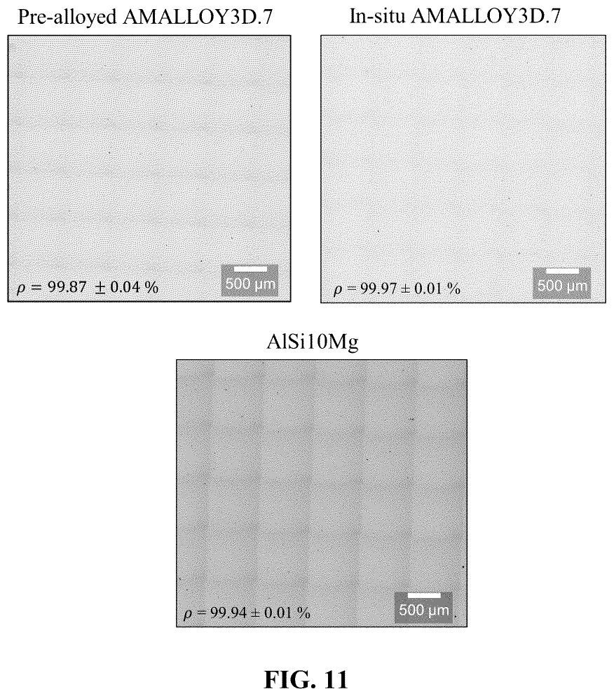

FIG. 11 shows micrographs the cross-sections of pre-alloyed AMALLOY3D.7 and in-situ AMALLOY3D.7 coupons manufactured using pre-alloyed and mixed powder batches, respectively, according to embodiments of the present disclosure, compared to commercially available AlSi10Mg alloy after PBF-LB. FIG. 11 also shows the relative densities of the alloys of the present disclosure (pre-alloyed AMALLOY3D.7 and in-situ alloyed AMALLOY3D.7) compared to the commercially available AlSi10Mg. All the AMALLOY3D.7 alloys exhibit excellent densification comparable with the standard AlSi10Mg benchmark, known for being an alloy characterized by a respectable propensity towards printability.

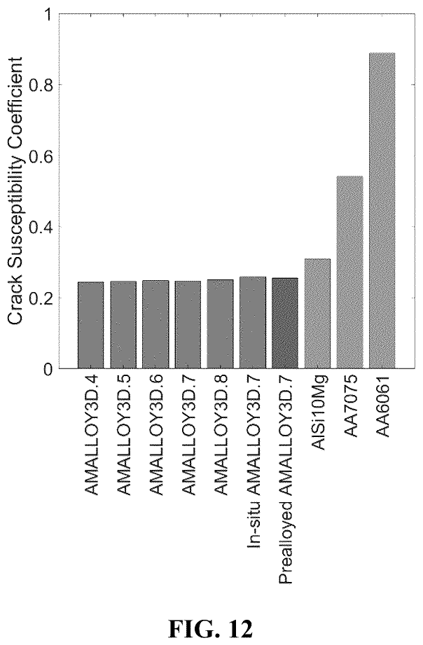

FIG. 12 is a bar graph showing the hot crack susceptibility coefficient of various alloy compositions according to embodiments of the present disclosure compared to commercial grades of aluminum alloys. The data reported in FIG. 12 demonstrates that the alloys of the present disclosure have lower CSC and thus are less prone to hot cracking phenomena than the high strength commercially available Al alloys evaluated, including AA7075 and AA6061, which are known in the art as being sensitive to hot cracking. In addition, the CSC values of the alloys of the present disclosure are lower than that of AlSi10Mg alloy, which, without wishing to be bound by theory, is generally indicative of excellent printability in the PBF-LB process without incurring cracking defects.

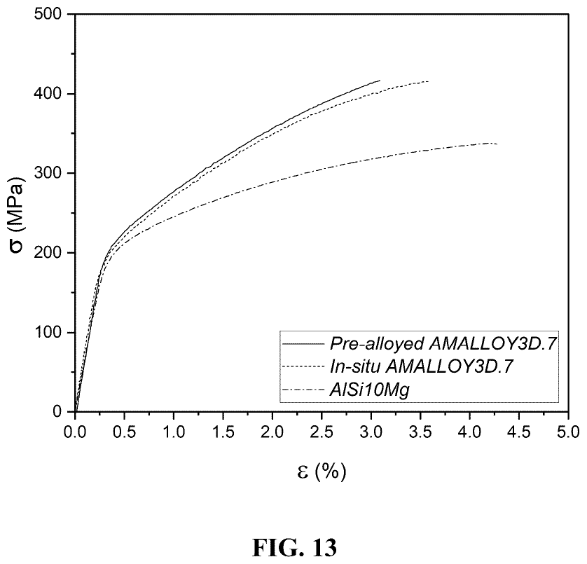

The results of the tensile tests on the as-built AMALLOY3D.7 alloy consolidated from pre-alloyed powder are summarized in FIG. 13 and TABLE 7. FIG. 13 is a graph of stress-strain curves of both AMALLOY3D.7 alloys of the present disclosure and a commercially available AlSi10Mg alloy. TABLE 7 shows the tensile properties of the same alloys. As can be seen from TABLE 7, the AMALLOY3D.7 alloys show yield strength (YS) and ultimate tensile strength (UTS), which are higher than the AlSi10Mg counterpart, with an increase of 41% and 25% in the pre-alloyed AMALLOY3D.7 grade and of 33% and 27% for the in-situ alloyed AMALLOY3D.7 grade. The highly supersaturated solid solution of Cu and Si atoms in the FCC-AL phase and the precipitation of Al₂Cu compounds (as shown in FIGS. 5A-D) are thought to be the major strengthening contributions for alloys of the present disclosure. Furthermore, the elongation at failure (EF) was not depleted by the presence of copper in both AMALLOY3D.7 grades. In addition, it was observed that the YS of pre-alloyed AMALLOY3D.7 grade increased 6% as compared to the counterpart in the in-situ alloyed AMALLOY3D.7, presumably owing to an improved homogeneity in the distribution of the alloying elements in the as-built material.

TABLE 7

| Alloy | YS (MPa) | UTS (MPa) | EF (%) |
|---|---|---|---|
| Pre-alloyed | 233.7 ± 7.4 | 413.9 ± 10.1 | 3.1 ± 0.6 |
| AMALLOY3D.7 | | | |
| In-situ | 219.9 ± 11.8 | 418 ± 18.2 | 3.6 ± 0.4 |
| AMALLOY3D.7 | | | |
| AlSi10Mg | 165.6 ± 5.1 | 329.3 ± 4.6 | 3.7 ± 0.2 |

### Example 4

The ultrasonic atomization of the powders disclosed herein was also evaluated. The AMALLOY3D.7 powder was produced via ultrasonic atomization using a RePowder atomizer (AMAZEMET, Poland) equipped with an induction unit AUS500 (Blue Power, US). The feedstock material was prepared by cutting pre-alloyed cast ingots having chemical composition of AMALLOY3D.7 into small chunks that were subsequently placed in a graphite crucible to start the induction melting process. The temperature was increased up to 900° C. to enable melting the feedstock, while being progressively purged with Argon gas cycles at temperatures of 25° C., 200° C., and 500° C. Before starting the atomization process, the molten alloy was kept at 900° C. for 5 minutes to homogenize the bath. TABLE 8 summarizes the parameters used for the ultrasonic atomization process. The initial graining pressure was set at 0.4 bar and then gradually increased to 0.5 bar after 1 minute. The liquid material was poured at an initial graining pressure of 0.4 bar onto a carbon fiber composite (CFC) plate vibrating at a frequency of 40 kHz/60 kHz with an amplitude of 100%, thus creating the conditions to break up the falling molten metal into small particles. Once the atomization process was completed, the induction system was cooled down to room temperature, and the resulting AMALLOY3D.7 pre-alloyed powder was collected and sieved using 90 μm mesh sieves.

TABLE 8

| Parameter | Value |
|---|---|
| Frequency [kHz] | 40/60 |
| Amplitude [%] | 100 |
| Melting Temperature [° C.] | 900 |
| Graining pressure start [bar] | 0.4 |
| Graining pressure end [bar] | 0.5 |
| Graining pressure time [min] | 1 |
| Turbo pressure max [bar] | 1.5 |

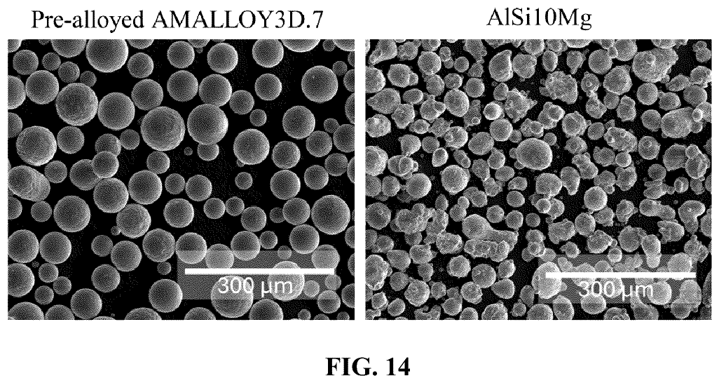

The pre-alloyed AMALLOY3D.7 powder produced using ultrasonic atomization exhibited a uniform and smooth surface, and a higher degree of sphericity with respect to the gas-atomized AlSi10Mg powder used in this work for the manufacturing of AlSi10Mg and in-situ AMALLOY3D.7 coupons. FIG. 14 shows SEM micrographs of pre-alloyed AMALLOY3D.7 powders according to embodiments of the present disclosure and AlSi10Mg produced using ultrasonic atomisation and gas atomization, respectively.

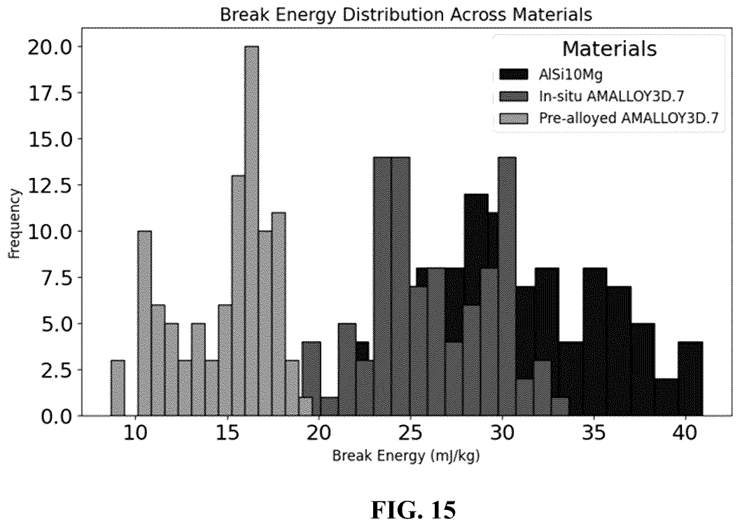

The uniform surface quality and high sphericity of the pre-alloyed ultrasonically atomized AMALLOY3D.7 powders significantly enhanced the powder flowability. The flowability potential of the powder samples was assessed using a Revolution Powder Analyzer (Mercury Scientific Inc., Newton, CT, USA). This analysis used 50 mL samples, drum rotation at 0.3 rpm, and capturing 20 frames per second via the camera. Over 100 avalanches were recorded for each powder sample. The break energy values, i.e., the energy required to initiate an avalanche, were measured on each sample, and their distribution is reported in FIG. 15. FIG. 15 shows the break energy distribution of AlSi10Mg, In-situ AMALLOY3D.7, and pre-alloyed AMALLOY3D.7 samples, according to embodiments of the present disclosure. The distribution curve for the pre-alloyed AMALLOY3D.7 produced using ultrasonic atomization is significantly shifted towards lower break energy values meaning that less energy is required for initiating an avalanche with respect to the powder samples having gas-atomized AlSi10Mg powder (i.e., AlSi10Mg and In-situ AMALLOY3D.7), suggesting a more consistent powder flow. These results are further summarized in TABLE 9.

TABLE 9

| Sample | Average Break Energy [mJ/Kg] |
|---|---|
| AlSi10Mg | 30.89 ± 4.7 |
| In-situ AMALLOY3D.7 | 26.25 ± 3.4 |
| Pre-alloyed AMALLOY3D.7 | 14.79 ± 2.7 |

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

### EMBODIMENTS

What is claimed is:

1. A method for forming a three-dimensional article comprising an alloy, the method comprising steps of:
(a) depositing a first layer of a precursor powder onto a build platform, wherein the precursor powder comprises aluminum, silicon, and copper;
(b) contacting the first layer of the precursor powder with an energy source to form a solid layer of the alloy;
(c) depositing a subsequent layer of the precursor powder on top of the solid layer; and
(d) contacting the subsequent layer of the precursor powder with the energy source to fuse the subsequent layer of the precursor powder to the solid layer;
thereby forming the three-dimensional article.

2. The method of claim 1, wherein the precursor powder comprises greater than or equal to 4 wt. % to less than or equal to 8 wt. % copper.

3. The method of claim 1, wherein the precursor powder comprises:
greater than or equal to 4 wt. % to less than or equal to 8 wt. % copper, and
greater than or equal to 8 wt. % to less than or equal to 11 wt. % silicon.

4. The method of claim 1, wherein the precursor powder comprises:
greater than or equal to 4 wt. % to less than or equal to 8 wt. % copper, greater than or equal to 8 wt. % to less than or equal to 11 wt. % silicon, and
greater than or equal to 75 wt. % to less than or equal to 88 wt. % aluminum.

5. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 0.8 wt. % iron, and
greater than or equal to 75 wt. % to less than or equal to 88 wt. % aluminum.

6. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 0.6 wt. % manganese, and
greater than or equal to 75 wt. % to less than or equal to 88 wt. % aluminum.

7. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 0.6 wt. % magnesium, and
greater than or equal to 75 wt. % to less than or equal to 88 wt. % aluminum.

8. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 0.3 wt. % titanium, and
greater than or equal to 75 wt. % to less than or equal to 88 wt. % aluminum.

9. The method of claim 1, wherein the precursor powder comprises:
greater than or equal to 4 wt. % to less than or equal to 8 wt. % copper,
greater than or equal to 8 wt. % to less than or equal to 11 wt. % silicon,
greater than or equal to 0.01 wt. % to less than or equal to 0.8 wt. % iron,
greater than or equal to 0.01 wt. % to less than or equal to 0.6 wt. % manganese,
greater than or equal to 0.01 wt. % to less than or equal to 0.6 wt. % magnesium,
greater than or equal to 0.01 wt. % to less than or equal to 0.3 wt. % titanium, and
greater than or equal to 75 wt. % to less than or equal to 88 wt. % aluminum.

10. The method of claim 1, further comprising preparing the precursor powder, wherein preparing the precursor powder comprises combining a copper-containing powder with a silicon-containing powder.

11. The method of claim 1, further comprising preparing the precursor powder, wherein preparing the precursor powder comprises combining an elemental copper powder with a pre-alloyed powder comprising silicon, aluminum, magnesium, or combinations thereof.

12. The method of claim 1, further comprising preparing the precursor powder, wherein preparing the precursor powder comprises sizing the precursor powder to an average particle size of greater than or equal to 1 μm to less than or equal to 100 μm.

13. The method of claim 1, further comprising preparing the precursor powder, wherein preparing the precursor powder comprises sizing the precursor powder to a particle size distribution of 1 μm to 100 μm.

14. The method of claim 1, further comprising preparing the precursor powder, wherein preparing the precursor powder comprises sizing the precursor powder via vibratory sieving.

15. The method of claim 1, further comprising preparing the precursor powder, wherein preparing the precursor powder comprises ultrasonic atomization.

16. The method of claim 1, further comprising (e) repeating steps (c) through (d) a plurality of times.

17. The method of claim 1, wherein the three-dimensional article has a density of greater than or equal to 99.2%.

18. The method of claim 1, wherein the three-dimensional article has a density of greater than or equal to 99.5%.

19. The method of claim 1, wherein the three-dimensional article has a density of greater than or equal to 99.9%.

20. The method of claim 1, wherein the alloy has a hardness of greater than or equal to 140 HV to 200 HV, a hot crack susceptibility coefficient of less than or equal to 0.3, and a density of 99.2% or greater.

21. A method for producing an alloy structure having a density of greater than or equal to 99.2%, comprising:
providing a precursor powder comprising greater than or equal to 4 wt. % to less than or equal to 8 wt. % copper to an additive manufacturing system; and
contacting the precursor powder with an energy source to form the alloy structure.

22. An alloy, comprising:
greater than or equal to 4 wt. % to less than or equal to 8 wt. % copper,
greater than or equal to 8 wt. % to less than or equal to 11 wt. % silicon, and
greater than or equal to 75 wt. % to less than or equal to 88 wt. % aluminum,
wherein the alloy has a hardness of greater than or equal to 140 HV to less than or equal to 200 HV, a hot crack susceptibility coefficient of less than or equal to 0.3, and a density of greater than or equal to 99.5%.
